(19) United States
(12) Patent Application Publication
(10) Pub. No.: US 2020/0223454 A1
(43) Pub. Date: Jul. 16, 2020

(54) ENHANCED SOCIAL MEDIA EXPERIENCE FOR AUTONOMOUS VEHICLE USERS

(71) Applicant: Intel Corporation, Santa Clara, CA (US)

(72) Inventors: Maik Fox, Rheinstetten (DE); Daniel Pohl, Puchheim (DE)

(73) Assignee: Intel Corporation

(21) Appl. No.: 16/830,495

(22) Filed: Mar. 26, 2020

(51) Int. Cl. B60W 60/00; G06F 3/01; G06K 9/00; G06N 3/08; G06N 20/00; G06Q 50/00

(52) U.S. Cl. CPC B60W 60/00139; B60W 60/00253; G06F 3/017; G06K 9/00832; B60W 2556/45; G06N 20/00; G06Q 50/01; B60W 2540/225; G06N 3/08

(57) ABSTRACT

Techniques are disclosed to process event data acquired via components that may be integrated as part of the autonomous vehicle's operational system, such as cameras and GPS systems. The event data may then be processed to generate processed event data based upon an analysis of various conditions occurring during, prior to, or shortly after a user's trip in an autonomous vehicle. The processed event data may represent one or more portions of sharable digital content such as a pre-edited video clip, a montage, an image, a series of images, etc. The user may access and then share these portions of sharable content to various platforms, such as social media platforms.

### TECHNICAL FIELD

Aspects described herein generally relate to enhanced autonomous vehicles and, more particularly, to enhancing trips in autonomous vehicles by providing users with content that is sharable to various platforms.

### BACKGROUND

One of the desirable benefits of travelling aboard an autonomous vehicle, e.g. a Robo-Taxi, is that passengers are able to spend their time doing things other than driving. The situation is comparable to travelling aboard a train or plane, or even a traditional taxi, but much more intimate. Therefore, particularly when a person is the sole passenger, a distraction is a very welcomed feature. Smartphones may be used for various purposes in this context, although it is very common for passengers to use smartphones to view or produce social media content.

However, when producing social media content (e.g. selfies, pictures of the current scenery, funny moments, etc.), portions of the vehicle, be it a plane, a Robo-Taxi, etc., tend to interfere or otherwise hinder the ability for passengers to take a desirable photo. For example, space constraints in the vehicle often lead to awkward selfie poses, usually showing the arms of the selfie taker in the resulting photo. As another example, it is generally difficult for passengers to share pictures or video to social media that contain content of the outside of the vehicle (e.g. while driving) captured from the inside of the vehicle. Doing so typically requires that a passenger roll down a window or slow down, and camera feeds that may provide video or images outside the vehicle are not accessible to the passenger. Therefore, there is room for improvement with respect to current user experiences while driving in autonomous vehicles.

### BRIEF DESCRIPTION OF THE DRAWINGS/FIGURES

The accompanying drawings, which are incorporated herein and form a part of the specification, illustrate the aspects of the present disclosure and, together with the description, and further serve to explain the principles of the aspects and to enable a person skilled in the pertinent art to make and use the aspects.

In the drawings, like reference characters generally refer to the same parts throughout the different views. The drawings are not necessarily to scale, emphasis instead generally being placed upon illustrating the principles of the disclosure. In the following description, various embodiments of the disclosure are described with reference to the following drawings, in which:

FIG. 1 illustrates an exemplary autonomous vehicle in accordance with various aspects of the present disclosure;

FIG. 2 illustrates various exemplary electronic components of a safety system of the vehicle in accordance with various aspects of the present disclosure;

FIG. 3 illustrates an exemplary autonomous vehicle system including a local processing unit in accordance with various aspects of the present disclosure;

FIG. 4A illustrates an exemplary block diagram of local data exchange in accordance with various aspects of the present disclosure;

FIG. 4B illustrates an exemplary block diagram of cloud-based data exchange in accordance with various aspects of the present disclosure;

FIG. 5 illustrates an exemplary autonomous vehicle data processing system including additional details associated with a local processing unit in accordance with various aspects of the present disclosure;

FIG. 6 illustrates an exemplary flow in accordance with various aspects of the present disclosure; and

FIG. 7 illustrates an exemplary flow in accordance with various aspects of the present disclosure.

The exemplary aspects of the present disclosure will be described with reference to the accompanying drawings. The drawing in which an element first appears is typically indicated by the leftmost digit(s) in the corresponding reference number.

### DETAILED DESCRIPTION

The following detailed description refers to the accompanying drawings that show, by way of illustration, exemplary details in which the aspects of the disclosure may be practiced. In the following description, numerous specific details are set forth in order to provide a thorough understanding of the aspects of the present disclosure. However, it will be apparent to those skilled in the art that the aspects, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring aspects of the disclosure.

As noted above, using smartphones in vehicles to capture and share content to social media and other platforms have various drawbacks. For instance, smartphone users are currently limited to creating content by taking photos from inside a vehicle, often through windows, which presents reflections and a limited field of view. In the context of an aircraft as a vehicle, smartphone users may even resort to taking photos of In-Flight-Entertainment-Systems that show images or video from outside aircraft cameras. Existing solutions that allow users to access images or video outside a vehicle while driving include integrated vehicular “dashcam” solutions, but such implementations are typically limited to providing images or video from the perspective of the vehicle's front view, and the acquisition of such image and/or video data needs to be triggered manually.

Therefore, to address these shortcomings, the aspects as described herein enable vehicle data to be accessed by user's smartphones. In the case of autonomous vehicles, the infrastructure, computing elements, and cameras of the autonomous vehicle are implemented to make the ride more enjoyable for the passengers and to help transportation-as-a-service providers to attract more customers with a differentiated service. The aspects as described herein thus help transform the usual forgettable ride in an indistinguishable autonomous vehicle into a memorable experience.

Various aspects are described throughout the disclosure with reference to autonomous vehicles or Robo-Taxis by way of example and not limitation. For instance, although the aspects described herein may be advantageously used as part of a Robo-Taxi architecture and business plan, the aspects described herein may be implemented as part of any suitable type of fully autonomous vehicle, semi-autonomous vehicle, or non-autonomous vehicles. Furthermore, the use of the aspects as described herein is also made with respect to the vehicle passengers, but this is also by way of example and not limitation. For instance, because the processing tasks as discussed herein are fully or semi-automated, the driver of any suitable type of vehicle in which the aspects described herein are implemented may likewise benefit, i.e. the driver's smartphone may be used in conjunction with the aspects as described herein in addition to or instead of passenger smartphones.

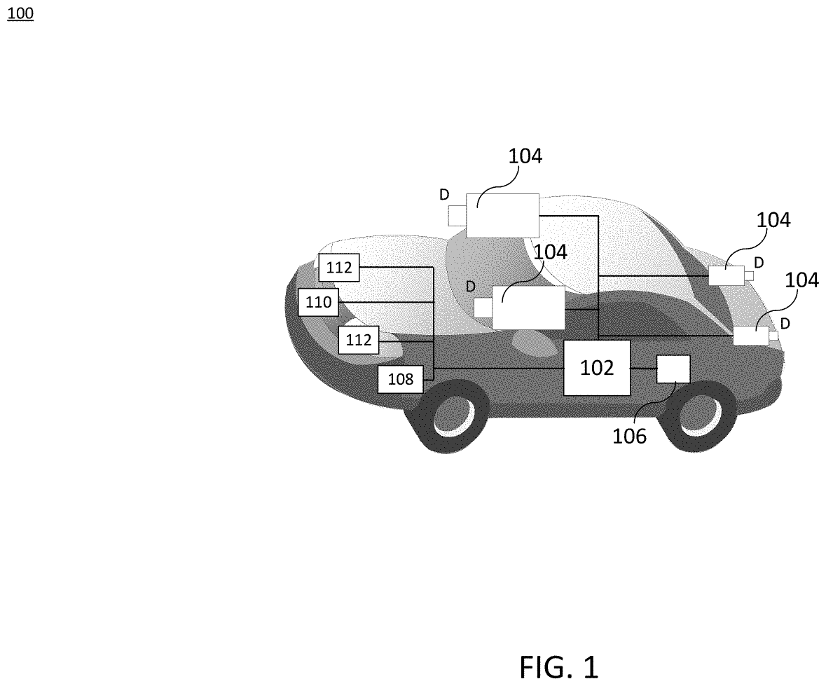

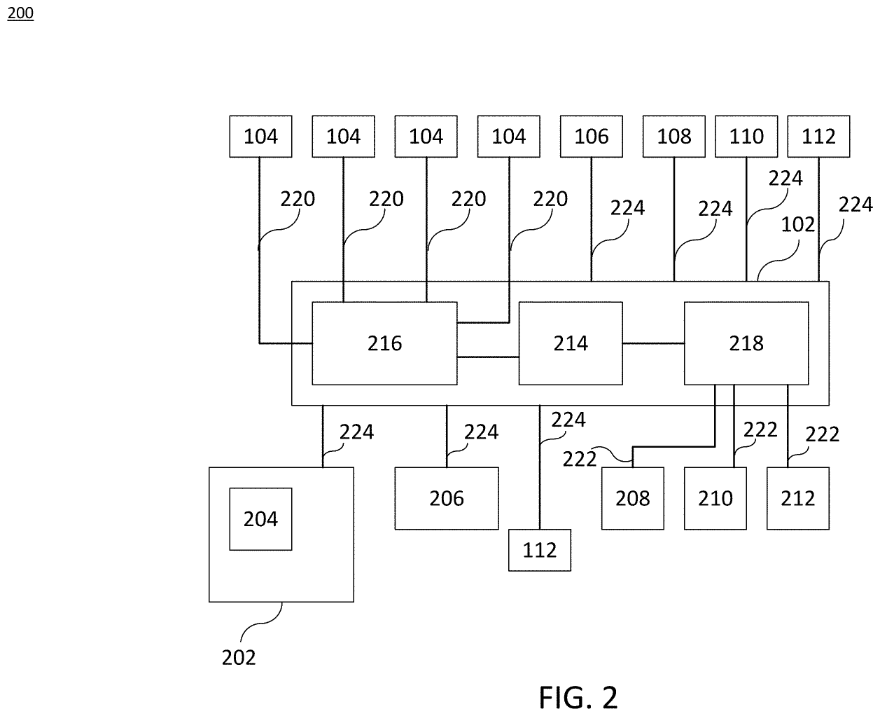

FIG. 1 shows a vehicle 100 including a safety system 200 (see also FIG. 2) in accordance with various aspects of the present disclosure. The vehicle 100 and the safety system 200 are exemplary in nature, and may thus be simplified for explanatory purposes. Locations of elements and relational distances (as discussed above, the Figures are not to scale) and are provided by way of example and not limitation. The safety system 200 may include various components depending on the requirements of a particular implementation.

As shown in FIG. 1 and FIG. 2, the safety system 200 may include one or more processors 102, one or more image acquisition devices 104 such as, e.g., one or more cameras, one or more position sensors 106 such as a Global Navigation Satellite System (GNSS), e.g., a Global Positioning System (GPS), one or more memories 202, one or more map databases 204, one or more user interfaces 206 (such as, e.g., a display, a touch screen, a microphone, a loudspeaker, one or more buttons and/or switches, and the like), and one or more wireless transceivers 208, 210, 212.

The wireless transceivers 208, 210, 212 may be configured according to different desired radio communication protocols or standards. By way of example, a wireless transceiver (e.g., a first wireless transceiver 208) may be configured in accordance with a Short Range mobile radio communication standard such as e.g. Bluetooth, Zigbee, and the like. As another example, a wireless transceiver (e.g., a second wireless transceiver 210) may be configured in accordance with a Medium or Wide Range mobile radio communication standard such as e.g. a 3G (e.g. Universal Mobile Telecommunications System—UMTS), a 4G (e.g. Long Term Evolution—LTE), or a 5G mobile radio communication standard in accordance with corresponding 3GPP (3rd Generation Partnership Project) standards. As a further example, a wireless transceiver (e.g., a third wireless transceiver 212) may be configured in accordance with a Wireless Local Area Network communication protocol or standard such as e.g. in accordance with IEEE 802.11 (e.g. 802.11, 802.11a, 802.11b, 802.11g, 802.11n, 802.11p, 802.11-12, 802.11ac, 802.11ad, 802.11ah, 802.11ax, 802.11ay, and the like). The one or more wireless transceivers 208, 210, 212 may be configured to transmit signals via an antenna system (not shown) via an air interface.

The one or more processors 102 may include an application processor 214, an image processor 216, a communication processor 218, or any other suitable processing device. Similarly, image acquisition devices 104 may include any number of image acquisition devices and components depending on the requirements of a particular application. Image acquisition devices 104 may include one or more image capture devices (e.g., cameras, charge coupling devices (CCDs), or any other type of image sensor). The safety system 200 may also include a data interface communicatively connecting the one or more processors 102 to the one or more image acquisition devices 104. For example, a first data interface may include any wired and/or wireless first link 220, or first links 220 for transmitting image data acquired by the one or more image acquisition devices 104 to the one or more processors 102, e.g., to the image processor 216.

The wireless transceivers 208, 210, 212 may be coupled to the one or more processors 102, e.g., to the communication processor 218, e.g., via a second data interface. The second data interface may include any wired and/or wireless second link 222 or second links 222 for transmitting radio transmitted data acquired by wireless transceivers 208, 210, 212 to the one or more processors 102, e.g., to the communication processor 218.

The memories 202 as well as the one or more user interfaces 206 may be coupled to each of the one or more processors 102, e.g., via a third data interface. The third data interface may include any wired and/or wireless third link 224 or third links 224. Furthermore, the position sensor 106 may be coupled to each of the one or more processors 102, e.g., via the third data interface.

Such transmissions may also include communications (one-way or two-way) between the vehicle 100 and one or more other (target) vehicles in an environment of the vehicle 100 (e.g., to facilitate coordination of navigation of the vehicle 100 in view of or together with other (target) vehicles in the environment of the vehicle 100), or even a broadcast transmission to unspecified recipients in a vicinity of the transmitting vehicle 100.

One or more of the transceivers 208, 210, 212 may be configured to implement one or more vehicle to everything (V2X) communication protocols, which may include vehicle to vehicle (V2V), vehicle to infrastructure (V2I), vehicle to network (V2N), vehicle to pedestrian (V2P), vehicle to device (V2D), vehicle to grid (V2G), and any other suitable protocols.

Each processor 214, 216, 218 of the one or more processors 102 may include various types of hardware-based processing devices. By way of example, each processor 214, 216, 218 may include a microprocessor, pre-processors (such as an image pre-processor), graphics processors, a central processing unit (CPU), support circuits, digital signal processors, integrated circuits, memory, or any other types of devices suitable for running applications and for data processing (e.g. image processing, audio processing, etc.) and analysis. In some aspects, each processor 214, 216, 218 may include any type of single or multi-core processor, mobile device microcontroller, central processing unit, etc. These processor types may each include multiple processing units with local memory and instruction sets. Such processors may include video inputs for receiving image data from multiple image sensors, and may also include video out capabilities.

Any of the processors 214, 216, 218 disclosed herein may be configured to perform certain functions in accordance with program instructions which may be stored in a memory of the one or more memories 202. In other words, a memory of the one or more memories 202 may store software that, when executed by a processor (e.g., by the one or more processors 102), controls the operation of the system, e.g., the safety system. A memory of the one or more memories 202 may store one or more databases and image processing software, as well as a trained system, such as a neural network, or a deep neural network, for example. The one or more memories 202 may include any number of random access memories, read only memories, flash memories, disk drives, optical storage, tape storage, removable storage, and other types of storage.

In some aspects, the safety system 200 may further include components such as a speed sensor 108 (e.g., a speedometer) for measuring a speed of the vehicle 100. The safety system may also include one or more accelerometers (either single axis or multiaxis) (not shown) for measuring accelerations of the vehicle 100 along one or more axes. The safety system 200 may further include additional sensors or different sensor types such as an ultrasonic sensor, a thermal sensor, one or more radar sensors 110, one or more LIDAR sensors 112 (which may be integrated in the head lamps of the vehicle 100), digital compasses, and the like. The radar sensors 110 and/or the LIDAR sensors 112 may be configured to provide pre-processed sensor data, such as radar target lists or LIDAR target lists. The third data interface (e.g., one or more links 224) may couple the speed sensor 108, the one or more radar sensors 110, and the one or more LIDAR sensors 112 to at least one of the one or more processors 102.

The one or more memories 202 may store data, e.g., in a database or in any different format, that, e.g., indicate a location of known landmarks. The one or more processors 102 may process sensory information (such as images, radar signals, depth information from LIDAR or stereo processing of two or more images) of the environment of the vehicle 100 together with position information, such as a GPS coordinate, a vehicle's ego-motion, etc., to determine a current location and/or orientation of the vehicle 100 relative to the known landmarks and refine the determination of the vehicle's location. Certain aspects of this technology may be included in a localization technology such as a mapping and routing model.

The map database 204 may include any suitable type of database storing (digital) map data for the vehicle 100, e.g., for the safety system 200. The map database 204 may include data relating to the position, in a reference coordinate system, of various items, including roads, water features, geographic features, businesses, points of interest, restaurants, gas stations, etc. The map database 204 may store not only the locations of such items, but also descriptors relating to those items, including, for example, names associated with any of the stored features. In such aspects, a processor of the one or more processors 102 may download information from the map database 204 over a wired or wireless data connection to a communication network (e.g., over a cellular network and/or the Internet, etc.). In some cases, the map database 204 may store a sparse data model including polynomial representations of certain road features (e.g., lane markings) or target trajectories for the vehicle 100. The map database 204 may also include stored representations of various recognized landmarks that may be provided to determine or update a known position of the vehicle 100 with respect to a target trajectory. The landmark representations may include data fields such as landmark type, landmark location, among other potential identifiers. The map database 204 can also include non-semantic features including point clouds of certain objects or features in the environment, and feature point and descriptors.

Furthermore, the safety system 200 may include a driving model (also referred to as a “driving policy model”), e.g., implemented in an advanced driving assistance system (ADAS) and/or a driving assistance and automated driving system. By way of example, the safety system 200 may include (e.g., as part of the driving model) a computer implementation of a formal model such as a safety driving model. A safety driving model may be or include an implementation of a mathematical model formalizing an interpretation of applicable laws, standards, policies, etc. that are applicable to self-driving (e.g. ground) vehicles. A safety driving model may be designed to achieve, e.g., three goals: first, the interpretation of the law should be sound in the sense that it complies with how humans interpret the law; second, the interpretation should lead to a useful driving policy, meaning it will lead to an agile driving policy rather than an overly-defensive driving which inevitably would confuse other human drivers and will block traffic, and in turn limit the scalability of system deployment; and third, the interpretation should be efficiently verifiable in the sense that it can be rigorously proven that the self-driving (autonomous) vehicle correctly implements the interpretation of the law. An implementation in a host vehicle of a safety driving model, illustratively, may be or include an implementation of a mathematical model for safety assurance that enables identification and performance of proper responses to dangerous situations such that self-perpetrated accidents can be avoided.

A safety driving model may implement logic to apply driving behavior rules such as the following five rules:

Do not hit someone from behind.

Do not cut-in recklessly.

Right-of-way is given, not taken.

Be careful of areas with limited visibility.

If you can avoid an accident without causing another one, you must do it.

It is to be noted that these rules are not limiting and not exclusive, and can be amended in various aspects as desired. The rules rather represent a social driving contract that might be different depending on the region, and may also develop over time. While these five rules are currently applicable in most of the countries, they might not be complete and may be amended.

As described above, the vehicle 100 may include the safety system 200 as also described with reference to FIG. 2. The vehicle 100 may include the one or more processors 102 e.g. integrated with or separate from an engine control unit (ECU) of the vehicle 100. The safety system 200 may in general generate data to control or assist to control the ECU and/or other components of the vehicle 100 to directly or indirectly control the driving of the vehicle 100.

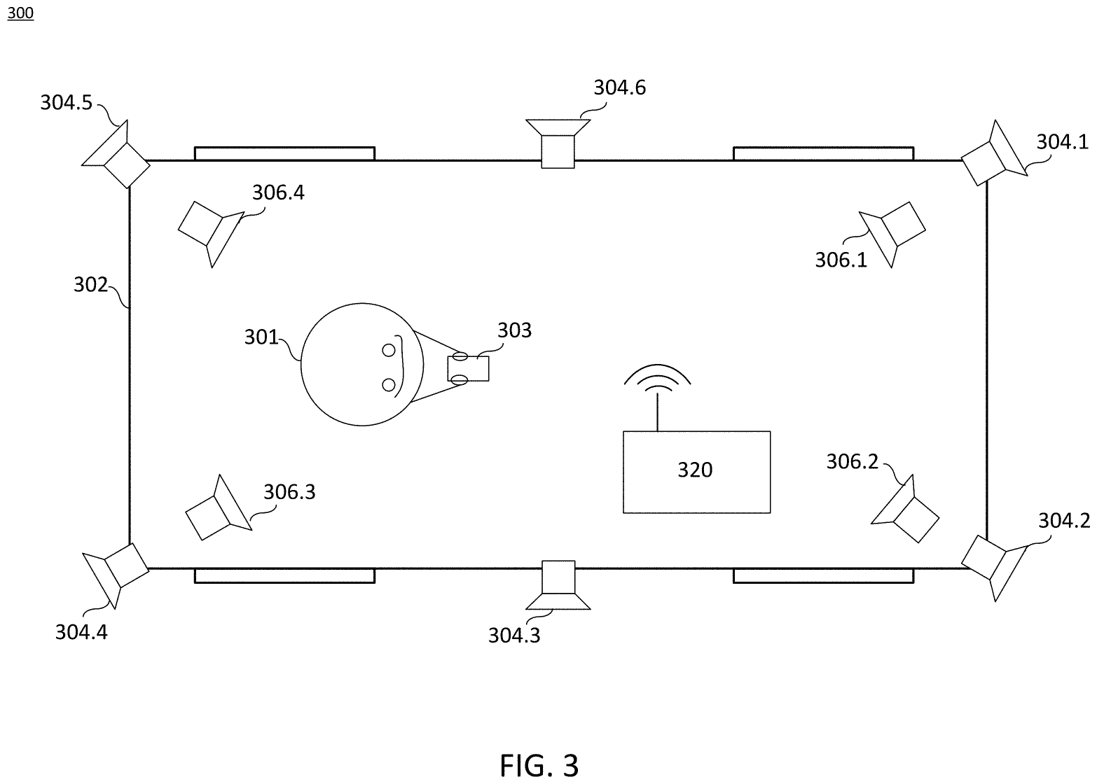

FIG. 3 illustrates an exemplary autonomous vehicle system including a local processing unit in accordance with various aspects of the present disclosure. The autonomous vehicle system 300 as shown in FIG. 3 includes an autonomous vehicle 302, which may be identified with the vehicle 100 as shown and described above with reference to FIG. 1. For example, the autonomous vehicle 302 includes any suitable number of outside image acquisition devices 304.1-304.6, of which 6 are shown in FIG. 3 as an example. These image acquisition devices 304.1-304.6 may be identified with the image acquisition devices 104 as shown and described above with reference to FIG. 1, which function to capture video data outside the autonomous vehicle 302. The outside image acquisition devices 304.1-304.6 may also include one or more microphones or otherwise control and/or access data associated with separate microphones that may be configured to record audio outside the autonomous vehicle 302 but are not shown in FIG. 3 for purposes of brevity. Thus, this video data may include images, videos, and/or audio data that is then provided to the one or more processors 102 to support autonomous driving functions or for other suitable purposes.

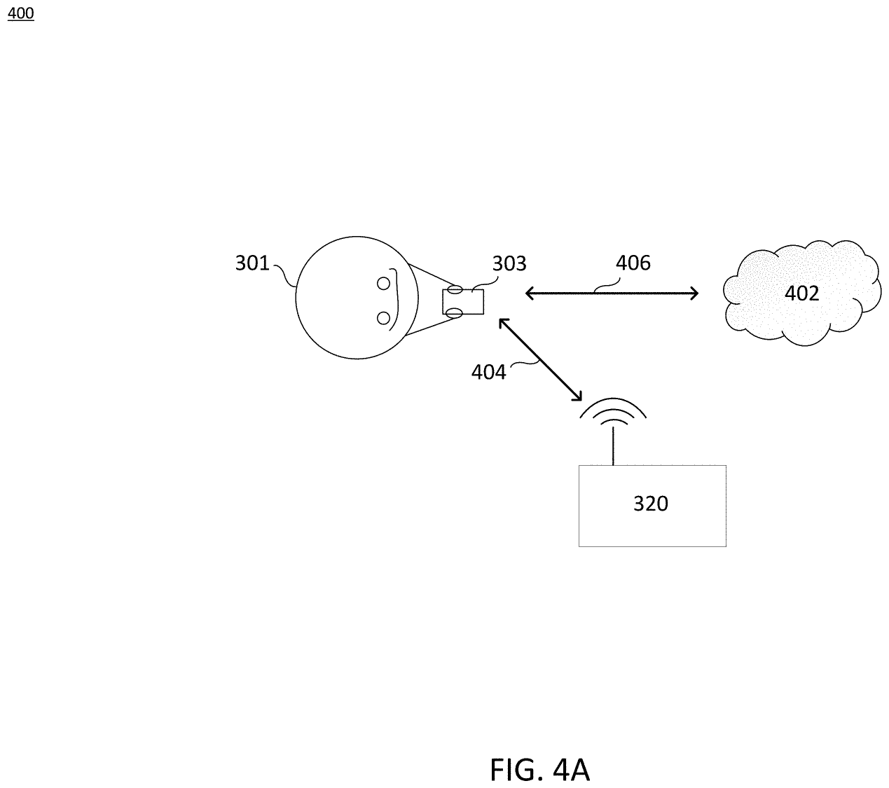

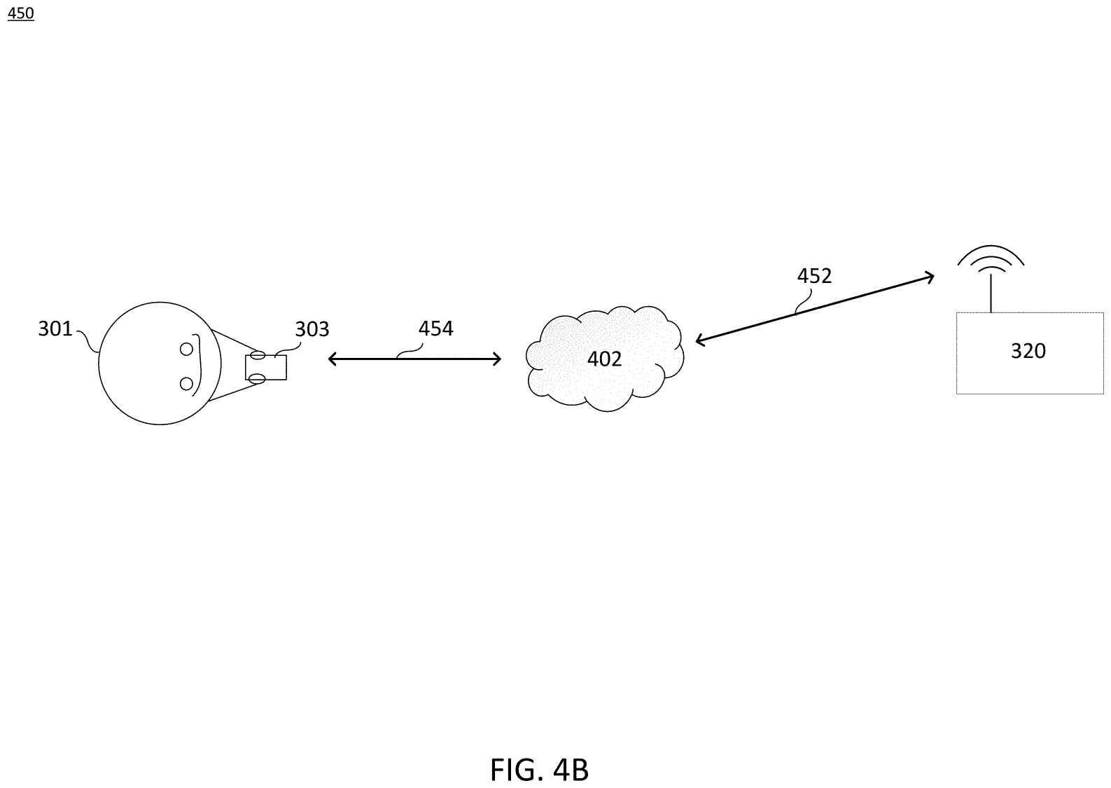

Additionally, aspects include the autonomous vehicle 302 implementing any suitable number of inside image acquisition devices 306.1-306.4, of which 4 are shown in FIG. 4 as an example. Similar to the outside image acquisition devices 304.1-304.6, the inside image acquisition devices 306.1-306.4 may be implemented as one or more image capture devices (e.g., cameras, charge coupling devices (CCDs), or any other type of image sensor), and may include one or more microphones or otherwise control and/or access data associated with separate microphones that may be configured to record audio inside the autonomous vehicle 302 but are not shown in FIG. 3 for purposes of brevity.

Further, the inside image acquisition devices 306.1-306.4 and/or the outside image acquisition devices 304.1-304.6 may be implemented as cameras having any suitable field of view, any suitable resolution, and may operate as 2D or 3D cameras (e.g. VR180 stereoscopic cameras). Moreover, the inside image acquisition devices 306.1-306.4 and/or the outside image acquisition devices 304.1-304.6 may be implemented using any suitable filter array, with any combination of monochromatic, IR sensitive cameras, etc. In various aspects, the inside image acquisition devices 306.1-306.4 may be configured in a similar manner as the outside image acquisition devices 304.1-304.6, although the inside image acquisition devices 306.1-306.4 need not operate in an outdoor environment.

Again, although the aspects as described herein are discussed with respect to the autonomous vehicle 302, the aspects as described herein are also applicable to non- or semi-autonomous vehicles. Therefore, one or more of the outside image acquisition devices 304.1-304.6 and/or the inside image acquisition devices 306.1-306.4 may or may not be implemented as part of a standard vehicle (i.e. a vehicle not using autonomous driving functions that use such cameras). However, it should be noted that many autonomous vehicles, such as Robo-Taxis, utilize cameras inside the vehicle cabin to record video of the inside of the vehicle for security purposes if needed. Moreover, some models of vehicles also implement a single camera inside the cabin, while other vehicles (even non-autonomous vehicles) also utilize 360-degree surround view cameras for parking. In any event, the video data provided by the inside image acquisition devices 306.1-306.4 and/or the outside image acquisition devices 304.1-304.6 may also include images, videos, and/or audio data that is then provided to the one or more processors 102 to support autonomous driving functions or for other suitable purposes.

Therefore, when present, the inside image acquisition devices 306.1-306.4 and/or the outside image acquisition devices 304.1-304.6 may be implemented as one or more cameras already in use by the autonomous vehicle 302. Alternatively, the inside image acquisition devices 306.1-306.4 and/or the outside image acquisition devices 304.1-304.6 may be installed separately from other components of the autonomous vehicle 302 as an aftermarket installation and/or to capture image data that is dedicated for the aspects as described herein. As another example, one or more of the outside image acquisition devices 304.1-304.6 may be installed, such as cameras that are specifically arranged and configured to capture content for various usage, including storing the content locally on a user's smartphone or other device, or sharing via social media platforms or other suitable platforms such as websites, cloud storage, etc. Additional examples include experiencing the environment surrounding the vehicle, monitoring users inside the vehicle (e.g., an infant in a backseat), etc. This may include, for instance, the use of outside cameras that are located at a higher point of the autonomous vehicle 302 to limit blocking their view by other vehicles. In other words, the aspects as descried herein may leverage camera systems that are already built into current or future vehicles—potentially with an optional package that a ride-for-hire vendor could add to the vehicle to increase the number and quality of cameras even further (e.g. adding VR180 stereoscopic cameras inside).

The local processing unit 320 (also referred to herein as local processing circuitry or a local processing system) may utilize the video data captured by the inside image acquisition devices 304.1-304.6 and/or the outside image acquisition devices 304.1-304.6 to realize the functions of the various aspects as further descried herein. To do so, the local processing unit 320 may be implemented in different ways depending upon the particular application and/or implementation of the autonomous vehicle 302. For instance, the local processing unit may be identified with one or more portions of the safety system 200 as shown in FIG. 2. Continuing this example, the local processing unit 320 may include one or more of the one or more processors 102 and accompanying image processor 216, application processor 214, and communication processor 218, as well as the one or more memories 202. Continuing this example, the local processing unit 320 may be integrated as part of an autonomous vehicle in which it is implemented as one or more virtual machines running as a hypervisor with respect to one or more of the vehicle's existing systems.

Thus, and as further discussed below, the local processing unit 320 may be implemented using these existing components of the safety system 200, and be realized via a software update that modifies the operation and/or function of one or more of these processing components. In other aspects, the local processing unit 320 may include or more hardware and/or software components that extend or supplement the operation of the safety system 200. This may include adding or altering one or more components of the safety system 200. In yet other aspects, the local processing unit 320 may be implemented as a stand-alone device, which is installed as an after-market modification to the autonomous vehicle 302. Although not shown in FIG. 3 for purposes of brevity, the local processing unit 320 may additionally include a user interface (e.g., the one or more user interfaces 206) such as a display, voice-recognition system, etc., to facilitate user interaction and enable a user to view the processed event data acquired via the aspects of the present disclosure as further discussed herein.

Regardless of the implementation of such a user interface, aspects include the user interface providing an option for users to “opt out” of the aspects of the present disclosure, thereby disabling the functionality of the aspects as described herein. The ability to opt in or opt out of these services may be made in any suitable manner and depending upon the particular implementation of the local processing unit 320, such as via a local processing unit 320 display (not shown) and/or via the user 301's mobile electronic device 303, for example. Moreover, aspects include the event data captured via the various image acquisition devices as discussed further herein having video or images with portions thereof (e.g. people's faces, license plate numbers, etc.) being blurred or otherwise modified by default to obscure or redact parts of images for privacy purposes, which may be a requirement to comply with some privacy law requirements depending upon a particular operating region. Certain aspects of the blurring or image modification may then be removed when a user decides to opt in to share the captured content, e.g. with a social media sharing services provided by the aspects of the present disclosure. As another example, processing of the event data may be dependent on the destination of the processed event data (i.e., the digital content). For instance, in the event that the communication is uploaded or communicated to a 3^{rd} party, different anonymization processing may be applied as compared to a case where the information is processed locally and delivered directly to a mobile device of the user.

In any event, the video data captured from the inside image acquisition devices 304.1-304.6 and/or the outside image acquisition devices 304.1-304.6, as well as other data received via other components of the autonomous vehicle 302 (e.g., location data representing one or more geographic locations along a route during an autonomous vehicle trip or when an autonomous vehicle otherwise interacts or navigates within an environment, sensor data, etc.), may represent “event data.” As the ride progresses, the event data thus forms part of an overall event data stream. The event data stream may then be transmitted to and stored in the local processing unit 320, local storage accessible by the local processing unit, or another suitable storage location (e.g., cloud storage). The local processing unit 320 may access the stored event data regardless of the storage location and locally process the stored event data. Alternatively, the local processing unit 320 may offload such processing tasks to an external component (e.g. a cloud computing platform), which may optionally be accessible via the mobile electronic device 303.

Moreover, and as further discussed herein, regardless of how the stored event data is processed, the aspects as described herein function to automatically generate processed event data by analyzing the event data in conjunction with various detected conditions, detected events of interest, locations, triggers, etc., that occurred during, prior to, or after the user 301's ride in the autonomous vehicle 302. The processed event data may represent a trip summary and/or one or more pieces (e.g., portions) of digital content associated with the detected events of interest (also referred to herein simply as “events”) such as, for example, a pre-edited video clip, a montage, an image, a series of images, etc. The process of generating the processed event data may also include formatting (either locally or part of an offloaded processing operation) each piece of digital content so as to be suitable for transmission (e.g. uploading or sharing) to one or more platforms (e.g., social media platforms) of which the user 301 may participate. As additional examples, the video can be cropped (e.g., to cut out overlapping regions, or to focus on a specific object or feature), warped (e.g., to correct optical distortions, adapt the perspective of the images, etc.) down-sampled, up-sampled, encoded, decoded, enriched with visual effects, rendered in 3D (using stereo images, optical flow (structure from motion)), synched with audio or not, etc.

For example, and as further discussed below, the automatic generation of digital content may include generating a video clip that can include video, visual, graphical ride data, as well as additional multimedia content, both user generated and content generated by software onboard the vehicle or downloaded from the cloud. Each story is thus specific and unique to a given ride, and can be shared with friends or the public over wireless communication links with specified users, via an online service, etc.

The processed event data may thus alternatively be referred to herein as sharable content, pieces or portions of digital content, etc. The portions of digital content, once created, may be shared, stored, transmitted, etc., in accordance with any suitable type of application for this which digital content may be desired. For example, the sharable content may, once created, be uploaded to or otherwise accessed via a mobile electronic device 303 associated with a user 301. The user 301 may then share this content via one or more applications as desired using the appropriate techniques provided in accordance with each particular application, as further discussed in detail below. For example, the sharable content may be trip summary data, a Graphics Interchange Format (GIF) file, an image file in JPEG format, a video snippet in MPEG-4 format, etc. Other uses of the portions of digital content may include a user locally saving files to be locally maintained on a user device such as a smartphone or other suitable device, saving the sharable content to a personal drive, connect to a printing service (not necessarily published), etc.

Although shown in FIG. 3 and often referred to herein as a smartphone, the mobile electronic device 303 may be implemented as any suitable type of electronic device that is configured to connect to a suitable data connection (e.g., mobile data and/or Wi-Fi) to share desired content with one or more platforms. Examples of the mobile electronic device 303 may include, in addition to a smartphone, a tablet computer, a phablet, a laptop computer, an integrated computer system used by the autonomous vehicle 302, a smartwatch, wearable smart technologies, etc.

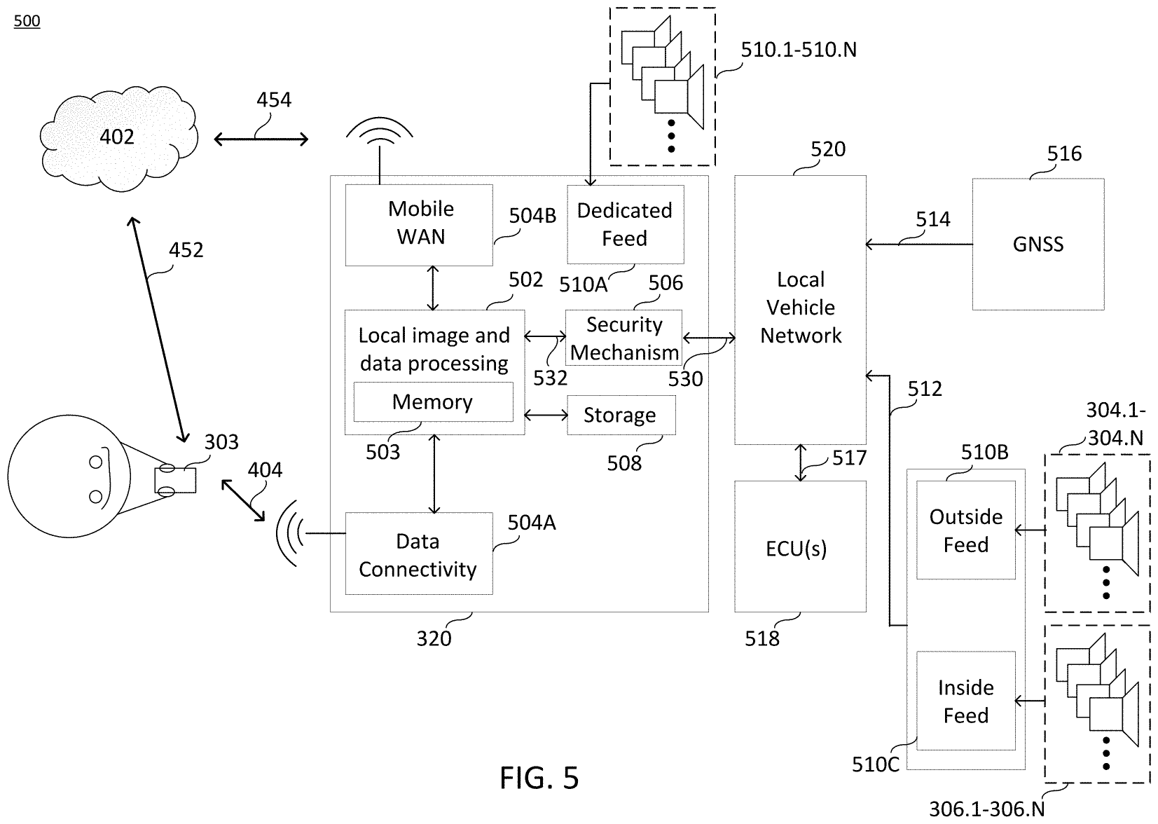

Additional details of the architecture of the local processing unit 320 and the manner in which the shareable content is created for uploading to particular platforms (e.g., social media platforms) are further discussed below with reference to FIG. 5. However, it is useful to first introduce the various data communication schemes that may be implemented in accordance with various aspects with reference to FIGS. 4A and 4B. Additional details associated with the autonomous vehicle system 300 are not shown in FIGS. 4A and 4B for purposes of brevity.

FIG. 4A illustrates an exemplary block diagram of local data exchange in accordance with various aspects of the present disclosure. In various aspects, the local processing unit 320 provides connectivity for one or more devices. For example, the local processing unit 320 may function to provide a local wireless network (e.g. a Wi-Fi network) and/or a cellular network (e.g., communications via LTE, “5G,” C-V2X standards), etc. In any event, upon coming within range of the local processing unit 320, the user 301's mobile electronic device 303 may connect to the local processing unit 320 in accordance with the appropriate wireless communication protocol to establish a connection and the exchange of data via the wireless link 404. In this aspect, the local processing unit 320 may also provide Internet access via the wireless link 404, although this specific connectivity is not shown in FIG. 4A for purposes of brevity.

Again, once the event data is processed by the local processing unit 320, processed event data is generated that may represent one or more pieces of sharable content. As shown in FIG. 4A, the user 301's mobile electronic device 303 may use the wireless link 404 to receive data, which may constitute the event data which the user 301 may edit himself to generate the sharable content, or the processed event data that may include the one or more pieces of formatted digital content. In any event, once the data is received and stored onto the user 301's mobile electronic device 303, the user may then share the content to the cloud 402 via the wireless link 406. In this example, the connection to the cloud 402 via the wireless link 406 may represent application programming interface (API) communications to any suitable platform to which the user 301 participates or otherwise has access to, thus enabling the direct posting and/or sharing of the sharable content as desired.

As further discussed below, the cloud 402 may also represent connections to a cloud-computing system, and thus the cloud 402 may represent one or more wired and/or wireless networks, cloud-based storage systems, cloud-based processing systems, etc. Alternatively, when the local processing unit 320 functions as a Wi-Fi or other wireless connectivity hotspot to provide Internet access, the user may instead share the content to any suitable platform via the Internet connection provided via the local processing unit 320, although this specific example is not shown in FIG. 4A for purposes of brevity.

FIG. 4B illustrates an exemplary block diagram of cloud-based data exchange in accordance with various aspects of the present disclosure. In an aspect, each of the local processing unit 320 and the user 301's mobile electronic device 303 is connected to the cloud 402 via a respective wireless link 452, 454. In other words, each of the wireless links 452, 454 may represent a wireless data connection to the cloud 402 in accordance with any suitable type of communication protocol. As noted above for FIG. 4A, the wireless links 452, 454 may likewise be made in accordance with any suitable wireless communication protocol and/or standard, such as a Wi-Fi network and/or a cellular network, for example. Again, the cloud 402 may represent, for example, connections to one or more platforms (e.g., social media platforms) as well as websites, cloud-computing, cloud-based storage systems, etc. The connectivity aspects as shown and described with reference to FIG. 4B may be preferable to those shown in FIG. 4A because the connectivity arrangement as shown in FIG. 4B does not require that the user 301's mobile electronic device 303 connect to the local processing unit 320, thus adding an additional layer of security.

In an aspect, the local processing unit 320 may identify the user 301 in different ways. For instance, if the user 301 used an application installed on the mobile electronic device 303, then the local processing unit 320 may identify the user 301 using these previously-established communications. The local processing unit 320 may then upload the processed or unprocessed event data to the cloud 402 via the wireless link 452 such that the data is available to the user 301 (and/or other users) via the wireless link 454. In various aspects, the local processing unit 320 may process the event data and upload the processed data to the cloud 402 in this way or, alternatively, the local processing unit 320 may offload the processing tasks to a cloud computing system by uploading the event data as unprocessed data via the wireless link 452. In any event, the cloud processing system may perform any (or all) portions of the processing as described herein with respect to the local processing unit 320, and the user 301 may access the processed event data from the cloud 402 for sharing to desired platforms via the wireless link 454 to the mobile electronic device 303. In other words, the local processing unit 320 does not necessarily need to process all (or any) of the event data locally. The decision to offload event data processing to the cloud 402 may depend, for instance, in accordance with one or more predetermined or learned rules such as the size of the event data, the available bandwidth, a particular application, a user preference, network speed and availability, etc. Advantageously, the uploading of event data and offloading of processing tasks by the local processing unit 320 to the cloud 402 may be performed as event data is collected (e.g., in real or near real-time), or after the user 301's trip has been completed.

Regardless of the manner in which event data is processed, accessed by the user 301, and then used to share digital content to various platforms, a primary concern is the security of the safety system 200 and, more generally, the integrity of the autonomous vehicle 302 as a whole. For instance, the various aspects as described herein cannot create reliability or security issues for the autonomous operations of the autonomous vehicle 302 due to a malicious hacking attempt that may compromise the ability of the autonomous vehicle 302 to safely function. Therefore, the aspects described herein introduce security measures as part of the architecture of the local processing unit 320 to ensure that the integral portions of the autonomous vehicle 302 cannot be accessed or tampered with while providing the user 301 with access to the event data gathered by the various image acquisition systems as discussed herein.

FIG. 5 illustrates an exemplary autonomous vehicle data processing system including additional details associated with a local processing unit in accordance with various aspects of the present disclosure. The local processing unit 320 is shown in FIG. 5 in further detail, and includes data connectivity circuitry 504A and mobile wireless area network (WAN) circuitry 504B. In various embodiments, the local processing unit may include either the data connectivity circuitry 504A, the mobile WAN circuitry 504B, or both depending upon the particular application and implementation of the local processing unit 320.

In an aspect, the data connectivity circuitry 504A may facilitate a mobile data connection between the local processing unit 320 and one or more electronic devices. For instance, the data connectivity circuitry 504A may facilitate a local Wi-Fi network connection between the local processing unit 320 and the mobile electronic device 303 as discussed above with respect to FIG. 4A. Thus, the data connectivity circuitry 504A may be implemented with any suitable number of transmitters, receivers, transceivers, etc., to facilitate communication via the wireless link 404 in accordance with any suitable number and/or type of communication protocols. Again, in some aspects, one or more portions of the local processing unit 320 may be associated with the safety system 200 as discussed with respect to FIG. 2. In such a case, the data connectivity circuitry 504A may include one or more separate wireless transceivers or transceivers that form part of the safety system 200 (e.g., the wireless transceivers 208, 210, and/or 212).

In an aspect, the mobile WAN circuitry 504B may facilitate a mobile data connection between the local processing unit 320 and the cloud 402, which may represent a connection to the Internet as well as cloud-based storage, cloud-based processing systems, one or more social media platforms, etc. For instance, the mobile WAN circuitry 504B may facilitate a mobile data connection between the local processing unit 320 and the cloud 402, as discussed above with respect to FIG. 4B. Thus, the mobile WAN circuitry 504B may be implemented with any suitable number of transmitters, receivers, transceivers, etc., to facilitate communication via the wireless link 454 in accordance with any suitable number and/or type of communication protocols. Again, the mobile WAN circuitry 504B may include one or more separate wireless transceivers or transceivers that form part of the safety system 200 (e.g., the wireless transceivers 208, 210, and/or 212).

As discussed above with respect to FIG. 3, the autonomous vehicle data processing system 500 includes one or more inside image acquisition devices 306.1-306.4 and one or more outside image acquisition devices 304.1-304.6. The one or more inside image acquisition devices are shown in FIG. 5 denoted as 306.1-306.N, indicating that any suitable number N of image acquisition devices may be present. This notation is likewise repeated for the one or more outside image acquisition devices 304.1-304.N. The local processing unit 320 may additionally or alternatively utilize any suitable number N of dedicated image acquisition units 510.1-510.N, which may also include one or more of the inside image acquisition devices 306.1-306.N and/or the outside image acquisition devices 304.1-304.N.

For example, the dedicated image acquisition units 510.1-510.N may be installed as components separate from the inside image acquisition devices 306.1-306.N and/or the outside image acquisition devices 304.1-304.N. As another example, the dedicated image acquisition units 510.1-510.N may be implemented by re-routing or re-purposing redundant, unused, or unnecessary image acquisition devices from among the inside image acquisition devices 306.1-306.N and/or the outside image acquisition devices 304.1-304.N. In any event, the dedicated image acquisition units 510.1-510.N may provide video data directly to the local processing unit 320 via the dedicated feed circuitry block 510A. As further discussed below, because of the dedicated nature of the dedicated image acquisition units 510.1-510.N, i.e., not being used for automated driving systems of the vehicle, the video data from the dedicated image acquisition units 510.1-510.N need not pass through the security mechanism 506, as the dedicated image acquisition units 510.1-510.N are severed from the rest of the vehicle in which the local processing unit 320 is implemented.

As shown in FIG. 5, each of the dedicated image acquisition units 510.1-510.N, the outside image acquisition devices 304.1-304.N, and the inside image acquisition devices 306.1-306.N is coupled to a respective feed circuitry 510A, 510B, 510C. Each of the feed circuitry 510A, 510B, and 510C may include any suitable number of hardware and software components to facilitate the transfer of video data captured by the coupled image acquisition devices to the local processing unit 320. For example, each of the feed circuitry 510A, 510B, and 510C may include one or more suitable data interfaces to receive the video data from each data acquisition device, data buffers, drivers, data buses, memory registers, etc.

Although the feed circuitry 510A, 510B, 510C are shown in FIG. 5 as being coupled to their respective image acquisition devices via a single link, it will be understood that each feed circuitry 510A, 510B, 510C may receive data separately and independently from each image acquisition device to which it is coupled. Therefore, each feed circuitry 510A, 510B, 510C may receive, store, and/or provide to the local processing unit 320 video data from any suitable number or subset of the image acquisition devices to which it is coupled. Moreover, video data may be temporarily stored in each of the feed circuitry 510A, 510B, and 510C, which is then transferred to the local processing unit 320 in accordance with any suitable communication protocol (e.g. Ethernet). As further discussed below, the local processing unit 320 may store the video feed data received from one or more of the feed circuitry 510A, 510B, and 510C in any suitable manner, such as in the data storage 508, the memory 503, and/or the cloud 402 (e.g., via transmission using the data connectivity circuitry 504A and/or the mobile WAN circuitry 504B).

Although only a single memory 503 is shown in FIG. 5 for purposes of brevity, aspects include the implementation of any suitable amount and/or number of memory systems and/or memory resources to store event data (e.g. video capture data). For example, ADAS systems typically attempt to limit the amount of video data that is recorded to achieve maximum efficiency, reduce power consumption, etc. In accordance with the aspects as described herein, however, more extensive video recording may be implemented.

The autonomous vehicle data processing system 500 also includes several components that may be part of the autonomous vehicle in which the local processing unit 320 is implemented, or provided as additional or dedicated components, as previously discussed. For example, the system 500 may include a GNSS system 516, which may be identified with the one or more position sensors 106 of the safety system 200 or a separate component. In any event, the GNSS system 516 may function to obtain geographic location data that tracks the position of the autonomous vehicle in which the local processing unit 320 is implemented to provide one or more geographic locations along a route of an autonomous vehicle trip. The GNSS system 516 may thus be implemented as a GPS or any other suitable location-acquisition device, and may be implemented as a known GNSS system architecture and having known components and functionality.

Regardless of the manner in which the GNSS system 516 is implemented, the GNSS system 516 is configured to provide location data to the local vehicle network 520 via one or more wired and/or wireless interconnections that are represented in FIG. 5 as link 514. The location data may include geographic coordinates, timestamp data, a time-synchronization signal, and/or any other suitable type of data that may be obtained via typical GNSS systems using geolocation services.

The local vehicle network 520 may represent a communication network associated with the vehicle in which the local processing unit is implemented, as well as one or more data adapters that may be coupled to this communication network. For example, the local vehicle network 520 may be implemented as one of more controller area network (CAN) bus lines that form the vehicle's CAN bus communication system. As another example, the local vehicle network 520 may include one or more additional networks and, when required, one or more data adapters that function to convert data from a CAN bus data format to another data format that might be more suitable or compatible with various vehicle components. For example, the local vehicle network 520 may include CAN bus to Ethernet adapters (and vice-versa) that function to convert video data received via the various image acquisition devices to the Ethernet protocol. As yet another example, the local vehicle network 520 may include one or more buses that are associated with various different communication protocols such that conversion from one communication protocol to another may not be necessary. Thus, the local vehicle network 520 may represent any suitable number of vehicle communication buses and/or networks and be configured to support vehicle communications in accordance with any suitable number and type of communication protocols. In this way, the local car network 520 may enable data communications among the various interconnected vehicle components. For example, the vehicle network 520 may include, together with the links 514 and 517 the first, second, and third data interfaces as discussed herein with respect to the safety system 200, which includes the links 220, 222, 224.

The electronic control units (ECU(s)) 518 may represent one or more electronic control units associated with the vehicle in which the local processing unit 320 is implemented. In an aspect, the ECU(s) 518 may include one or more vehicle components that utilize the data provided by the safety system 200 as discussed herein to realize Advanced Driver-Assistance Systems (ADAS) functionality. These ADAS functionality may include, for example, semi- or full-autonomous driving solutions that utilize various sources of sensor and other input data as explained above with reference to FIGS. 1 and 2.

Moreover, the ECU(s) 518 may utilize any suitable type of data that is available via the local vehicle network for this purpose. For example, the ECU(s) 518 may utilize the location data provided by the GNSS system 516, the video data provided by the outside image acquisition devices 304.1-304.N and/or the inside image acquisition devices 306.1-306.N, as well as any other suitable type of data available via the local vehicle network 520, which may (but need not be) used for ADAS functionality such as radar data, Lidar data, sensor data, weather conditions, etc. As an illustrative example, the location data may be used by the various components connected to the local vehicle network 520 (e.g., the ECU(s) 518) to facilitate autonomous driving functionality, to determine driving routes, or for any other suitable purpose depending upon the type of particular type of vehicle in which the local processing unit is implemented and the capabilities of the vehicle.

The local processing unit 320 may likewise access any suitable portion of the data utilized by the ECU(s) 518 to identify one or more events that occur prior to, during, or after a ride in the vehicle in which the local processing unit 320 is implemented, which may then be used to create processed event data. For example, the term “event data” as used herein may include any combination or subset of the data utilized by the ECU(s) 518, which may include location data provided by the GNSS system 516, the video data provided by one or more of the feed circuitry 510A, 510B, and/or 510C associated with the respective image acquisition devices coupled thereto, audio data included in video data or acquired via separate microphones, sensor data, etc.

With the exception of any data received via the dedicated feed circuitry 510A, the local processing unit 320 may receive the event data from the local vehicle network via the security mechanism 506. The security mechanism 506 may be, for example, a “unidirectional firewall” that is implemented as a hardware solution, as a software solution, or a combination of these. Regardless of the manner in which the security mechanism 506 is implemented, aspects include the security mechanism 506 providing the event data to the local image and data processing circuitry 503 via the links 530, 532, such that data cannot be transmitted from the local processing unit 320 to the local vehicle network 520. In an aspect, the security mechanism 506 may process data received from the local vehicle network 520 separately from the processing of user data that occurs in the local processing unit 320 (e.g., receiving ride requests, identifying the user, etc.). This ensures that access to the vehicle's critical networks, which operate in a highly secure, protected, environment are not accessible in the event that the local processing unit 320 is compromised by a software attack.

For example, the link 530 as shown in FIG. 5 may be configured as one or more data interfaces configured to work in conjunction with the security mechanism 506. Although not shown in FIG. 5 for purposes of brevity the link 530 may also include various hardware and/or software components such as processors, data downsamplers, buffers, drivers, etc. The link 530 may function, in various aspects, to selectively provide specific types of data from the local vehicle network 520 in one direction and/or to downsample the data to decrease bandwidth and processing requirements. For example, the link 530 may function as a data interface that selectively provides, in conjunction with the security mechanism 506, event data such as media data (e.g., video, audio, etc.) to the security mechanism 506 for further processing. The link 530 may also function in conjunction with the security mechanism 506 to ensure that only specific types of authorized communications are allowed from the local processing unit 320 to the local vehicle network 520 (e.g. access requests).

In an aspect, the security mechanism 506 is configured to prevent specific types of data (e.g., unauthorized requests or data transmissions) from being transmitted in the opposite direction, i.e. back to the local vehicle network 520 via the link 530. In this way, the local processing unit 320 is effectively “sandboxed” from the secure environment in which the autonomous vehicle's various systems may operate and, of particular importance, the ECU(s) 518. As a result, a malicious attack on the local processing unit 320 via the wireless links 404, 454, for example, even if successful, prevents attackers from communicating with the other critical safety components of the autonomous vehicle for potentially nefarious means. In this way, the security mechanism 506 may function to transfer data from a more secure environment of the autonomous vehicle, which may be associated with various critical components connected to the local vehicle network 520, to the less environment of the local processing unit 320 (e.g., the memory 503 and other external destinations such as the cloud 402).

Thus, the local image and data processing circuitry 502 may operate on the received event data in an environment having a level of security that is different (e.g. less secure) than that of the local vehicle network 520 and/or other components of the autonomous vehicle. The term “less secure” in this context does not mean that the data can be openly accessed. Rather, the level of security of the environment in which the local processing unit 320 operates, as well as other devices that receive the processed event data form the local processing unit 320, may be identified as being less secure (e.g., a lower level of encryption, less data authentication measures, less data security measures, etc.) as compared to the level of the security environment of the autonomous vehicle from which the event data is received.

Again, in various aspects, the security mechanism 506 and/or the link 530, which may function as a data interface, may be implemented as any suitable combination of hardware and/or software. For instance, the security mechanism 506 and/or the link 530 may function to selectively arbitrate or otherwise cantor the flow of specific types of data between the local processing unit 320 and the local vehicle network 520, as noted above. As another example, the security mechanism 506 may be implemented as a software solution, with ports associated with the transmission of data between the local processing unit 320 and the local vehicle network 520 being unmapped, not configured, or unused in a manner that cannot be re-enabled via the local processing unit 320. As another example, the security mechanism 506 may be implemented as a hardware solution that does not include the physical ports, drivers, buffers, etc. (or which are otherwise physically removed or disabled) that would otherwise enable data flow in the direction from the local processing unit 320 to the local vehicle network 520. As yet another example, the security mechanism 506 may be setup as a “data diode,” which may include optical or other data-carrying mediums that only allow the security mechanism 506 to receive data from, and not transmit data to, the local vehicle network 520. A hardware implementation of the security mechanism 506 may be particularly useful, for example, if the video streaming and data transport in the local vehicle network 520 utilizes known techniques for video data transport such as UDP (stateless packet transmission) and/or multicast/anycast techniques (sending to multiple recipients at the same time).

Processing Event Data

Again, the local image and data processing circuitry 502 may receive event data via the security mechanism 506, which may include the location data, video data, etc. which is also accessible by the ECU(s) 518 via the local vehicle network 520. The event data may additionally or alternatively include video data received via the dedicated feed circuitry 510A, which is not obtained via the security mechanism 506. The local image and data processing circuitry 502 may be implemented as any suitable number and/or type of hardware processors and/or software tools, executable code, logic, etc., to perform various types of analyses on the event data to identify events and create processed event data once the events are identified. Because the local image and data processing circuitry 502 may analyze images, video, audio, and/or location data included in the event data, the local image and data processing circuitry 502 may be implemented with appropriate processing tools to execute these types of analyses, e.g. image analysis/processing, audio analysis/processing, etc. The local image and data processing circuitry 502 may be part of the local processing unit 320 and, in various aspects be an integrated part of the autonomous vehicle in which the local processing unit 320 is implemented. In other aspects, the local image and data processing circuitry 502 may be a dedicated local processing unit as discussed above.

In aspects in which the local processing unit 320 is part of the autonomous vehicle, the local image and data processing circuitry 502 may be identified with one or more portions of the safety system 200 as shown and discussed herein with reference to FIG. 2. For example, the local image and data processing circuitry 502 may be identified with a portion of or the entirety of the one or more processors 102, and the memory 503 and/or storage 508 may be identified with portions of or the entirety of the memories 202. Regardless of the particular implementation, the local processing unit 320 is configured to store the event data prior to and after being processed (i.e. as processed event data or pieces of sharable content) in the storage 508 and/or the memory 503, which each may be implemented as any suitable type of volatile or non-volatile memory such as a hard disk, flash memory, etc. The memory 503 may form part of the local image and data processing circuitry 502, and each of the storage 508 and the memory 503 may be implemented as a non-transitory computer-readable medium. In an aspect, the memory 503 may store machine-readable executable code that, when executed by the local image and data processing circuitry 502, causes the local image and data processing circuitry 502 and/or the local processing unit 320 to analyze event data, generate processed event data, and to otherwise carry out the various aspects as described herein.

The local image and data processing circuitry 502 may analyze the event data to detect various events to generate the processed event data in different ways. Various examples of the types of events that may be identified via analysis of event data are provided below, although these are by way of example and not limitation. For example, a trained system (e.g., a machine-leaning algorithm) can be used alone or in combination with computer processing algorithms. As an illustrative example, facial recognition and blurring can be machine learning based. Regardless of the particular type of event that is detected, the local image and data processing circuitry 502 is configured to generate processed event data that may be made available to the user 301's mobile electronic deice 303 for sharing to an appropriate platform, or for other purposes. In each of the examples provided below, the local image and data processing circuitry 502 may receive event data and generate processed event data that is provided to the user 301 via the mobile electronic device 303 in real-time, during a trip, prior to the start of a trip, or once a trip has ended. The processed event data may contain, for instance, one or more pieces of digital content such as one or more pre-edited videos. The pre-edited videos may be cut in a manner that is approximately centered about or otherwise temporally spaced about one or more identified events as a result of the event data analysis.

Trip Summary

In aspects in which the local processing unit 320 is implemented as part of a Robo-Taxi or a for-hire autonomous vehicle, the user 301 may request a pickup that is processed via appropriate communications with the autonomous vehicle. At this time, the autonomous vehicle (e.g., the ECU(s) 518) may receive the location of the user 301, the destination, the requested time for pickup, and the identity (e.g., user ID) of the user 301. In this case, the local image and data processing circuitry 502 may also receive this information as part of the event data. This information may be processed by the local image and data processing circuitry 502 to provide trip summary information such as the route taken, a pickup time, a drop off time, a duration of the trip, etc.

Using Event Data to Record User

The trip summary data noted in Example 1 above may be provided to the user. However, aspects also include the local image and data processing circuitry 502 using this information to intelligently and automatically provide sharable content to the user 301 that may be particularly relevant for sharing to social media platforms. For example, the video data may be acquired with reference to a common system clock or otherwise be synchronized to real time, such that the recorded video data is then correlated to specific time periods associated with the user 301's trip. Aspects include the local image and data processing circuitry 502 matching specific time periods of a trip, such as the start or end of the trip indicted in the summary data, a time when the user 303 first entered the vehicle, etc., to specific portions of the video data.

Continuing this example, the local image and data processing circuitry 502 may implement object tracking (independently or relying on object tracking data provided by the safety system 200 in which the local processing unit 320 is implemented) to locate and track persons within the entire 360 degree view of video data, and then extract from this wider field of view a narrower field of view during this time period that only includes the tracked object of interest (e.g., the user 301 for which visual identification data can be obtained from a user profile, previous rides, etc.). This advantageously reduces the size of the video data required for analysis to a window that encompasses specific time periods in the vehicle trip summary data. As an illustrative example, the user 301 may book a ride to the airport to go on vacation. When the user 301 is initially picked up, the user 301 is likely to be in a good mood and smiling while rolling her suitcase towards the Robo-Taxi. Using the trip start time and the object tracking data, the local image and data processing circuitry 502 may process the event data to provide a 5, 10, 15, 20, etc., second video clip of the user 301 approximately centered about the time of this event. After the trip has ended, the user 301 may then receive or otherwise access this video clip, which can then be shared, e.g., to various platforms. It will be appreciated that the object tracking feature can be used in any other manner to initiate data recording and sharing with the user, e.g., object tracking can be initiated at a certain distance from the host vehicle (which can be determined by the sensors onboard the host vehicle), upon user activation (through a smartphone app or gesture recognition), when a user enters a communication range for a suitable communication means (e.g. near field communication range, Bluetooth, etc.).

Using event data to provide outside highlights and events

The event data also include location data that tracks the geographic location of the autonomous vehicle during a trip, which is also synchronized with or otherwise referenced to the time recordings of the video data. Therefore, aspects include the local image and data processing circuitry 502 processing the event data to determine, from the location data, whether a specific landmark is passed during the trip. This may be performed, for instance, by accessing a geographic coordinate or geolocation database (e.g., stored in the storage 508) to determine when the autonomous vehicle is within a predetermined threshold distance of one of the stored, predetermined locations indicative of a point of interest.

Continuing this example, the local image and data processing circuitry 502 may identify, from an analysis of the video data a field of view of one or more outside image acquisition devices 304.1-304.N that is directed towards the point of interest. This determination may be made, for example, using object tracking within the overall 360 degree view of data available from the outside image acquisition devices 304.1-304.N. As another example, this determination may be made using sensor data (e.g. compass data) that is received as part of the event data via the local vehicle network 520 and/or the location data) to identify the heading and orientation of the autonomous vehicle when the proximity to the landmark (i.e. the event) was detected. Continuing this example, the orientation of the 360 degree video may be known using data that is provided by the outside image acquisition devices 304.1-304.N when stitching 360 degree videos together using known techniques. Then, using the determined direction towards the identified landmark from the sensor or location data, the entire 360 degree view of video data available may be reduced to a narrower field of view in a direction of the landmark and during a time period when the landmark was identified as being in proximity to the autonomous vehicle. As an illustrative example, the local image and data processing circuitry 502 may process the event data to provide a video clip of a particular landmark as passed en route to or from the airport, which may be captured from the outside image acquisition device 304.1 based upon the orientation of the autonomous vehicle when the landmark was passed. After the trip has ended, the user 301 may then receive or otherwise access this video clip, which can then be shared to various platforms.

As another example, the local image and data processing circuitry 502 may access a common real time clock and thus be aware of the current date and time of day. Therefore, aspects include the local image and data processing circuitry 502 processing the video data to analyze the video data from specific image acquisition sources in a different way based upon the time and date information. As an illustrative example, if the current date is July 4, and the current time is 9:30 pm, then the local image and data processing circuitry 502 may process the event data to only analyze video data associated with the outside image acquisition devices 304.1-304.N to identify events that are expected during this time and date (e.g., fireworks). Then, the local image and data processing circuitry 502 may provide, as the processed event data, a video clip of one or more of the events contained within this video data. After the trip has ended, the user 301 may then receive or otherwise access this video clip, which can then be shared to various platforms.

Using Event Data to Increase Data Accessibility

As discussed herein, the event data may include video data, audio data, and location data that is acquired by one of more components of the autonomous vehicle (or other external devices such as aftermarket components) during a trip. These specific types of event data are by way example and not limitation, however, and the aspects as described herein may include the use of event data having any suitable type of information associated with the vehicle in which it is implemented. For example, because the security mechanism 506 provides appropriate isolation for the secure environment of the autonomous vehicle data processing system 500, aspects include the local image and data processing circuitry 502 providing processed event data that includes autonomous vehicle system data that would not otherwise be extractable from the autonomous vehicle, but may nonetheless contain useful information. For example, the autonomous vehicle system data may include log data that is recorded by the autonomous vehicle while navigating an environment (e.g., during a trip), sensor data acquired via various autonomous vehicle components such as LIDAR and/or radar, etc.

As additional examples, the event data may additionally or alternatively include data received from other external devices within communication range of the autonomous vehicle such as smartphones or smart wearable devices. In the case of external devices, the event data may contain biosensor feedback data such as pulse information, blood pressure data, etc. In some aspects, this biosensor feedback data may additionally or alternatively be used to identify the events when the event data is processed. For instance, a pulse rate in excess of a threshold value over a predetermined time window may be used to identify events of interest in the processed event data.

The accessibility of the aforementioned autonomous vehicle system data and biosensor feedback data may be used for a variety of applications, in accordance with various aspects. For instance, the autonomous vehicle system data may be synchronized with other portions of the event data. Thus, when the local image and data processing circuitry 502 analyzes the event data, then the video data, images, audio, locations, etc., included the event data may be combined or “stitched” with the biosensor feedback data. For example, pulse information may be displayed juxtaposed with one or more portions of digital content to show the user's “bio-reaction” to specific events of interest. This data stitching may be applied to any suitable type of event data, with the digital content including any portions thereof displayed as part of the same digital content such as multiple images and/or videos displayed together, for example.

As another example, the autonomous vehicle system data may include information that facilitates a representation of various types of data collected by the autonomous vehicle sensors while navigating an environment. This may include 3D and/or 4D data that is used for autonomous vehicle navigation or recorded for other purposes. In various aspects, the event data may include this 3D and/or 4D data, which may include information such as, for instance, an indication of the ego vehicle location, surrounding streets, a driving log and/or summary of one or more trips in real time, etc. Aspects include the local image and data processing circuitry 502 analyzing the event data to extract such autonomous vehicle system data, which may then be formatted, exported, and/or shared to other users for use with suitable applications to view the data. For example, the digital content may include events of interest during a trip, a trip summary, an entire trip, etc., being formatted for use with virtual reality (VR) applications. In this way, the generation of processed event data that includes highlights or the entirety of a user's journey could be shared with other users and viewed in 3D or 4D, for instance. The generation of the digital content of a specific type and/or the identification of specific events of interest may be triggered via a user's interaction with a suitable user interface (e.g. user interface 206) as discussed herein using a touch panel, the user's electronic device, voice commands, etc.

With respect to the use of autonomous vehicle system data, aspects include the local image and data processing circuitry 502 analyzing the event data to extract driving log data and/or sensor data such that a trip (or portions of interest thereof) may be subsequently viewed via a suitable application or shared with a party of interest. Continuing this example, the digital content may include extracted autonomous vehicle log data regarding acceleration, cornering, braking, etc., images and/or video captured from cameras disposed outside the vehicle, etc., that may be shared with insurers as part of an accident investigation. Such autonomous system data may additionally or alternatively be used for accident reconstruction, for example.

Using event data to provide outside highlights and events using user action profiles

Again, the video data may include recorded footage from both the outside of the vehicle and the inside of the vehicle. Therefore, aspects include the local image and data processing circuitry 502 analyzing the video data using one or more suitable image processing techniques to detect one or more events based upon the actions of the user 301 during a trip. For instance, the event data may be analyzed and, in particular, the video data of the user 301 inside the vehicle may be analyzed to identify one or more user actions that match a predetermined action profile, which may include learned action profiles that may be stored in the storage 508 or otherwise accessible via the local processing unit 320. A detected action profile may include, for example, a gaze event that is associated with the direction of gaze of the user 301. This may be determined, for example, by determining that the user 301 is looking out the window in a particular direction for a time period that exceeds a threshold time period, thus matching the predetermined action profile. The determination of a user's gaze and gaze direction are known techniques that may be determined via known object tracking and/or head orientation tracking tools from an image analysis of the video data. In another example, user behavior can be correlated with user selected events which are uploaded or shared by the user, and in this manner, machine learning techniques can be used to train a neural network to identify events of interest by user reaction or by any other perceptible queues.

In various aspects, the identification of the different action profiles may be performed in accordance with any suitable machine learning algorithm. The machine learning algorithm may be trained in accordance with the particular implementation thereof using, for instance, training data that includes various user gestures, motions, postures, or any other suitable type of behavior for which an action profile may subsequently be detected. For example, the memory 503 may store the training data such that the local image and data processing circuitry may execute a suitable machine learning algorithm. In doing the local image and data processing circuitry 502 may then detect the event of interest by classifying the action of a person located within the autonomous vehicle as matching one of the predetermined action profiles in accordance with the training data.

When a gaze event is detected, aspects include the local image and data processing circuitry 502 identifying a field of view of one or more specific outside image acquisition devices 304.1-304.N that is directed towards (so as to capture video in) the direction that matches the direction of the user 301's gaze based upon sensor data (e.g. compass data) and the heading of the autonomous vehicle. As discussed above, the entire 360 degree view of video data available may be reduced to a narrower field of view in a direction of the user 301's gaze and during a time period when the gaze event was identified. As an illustrative example, the local image and data processing circuitry 502 may process the event data to provide a video clip of video captured en route to or from the airport, which may be captured from the outside image acquisition device 304.2 based upon the orientation of the autonomous vehicle when the gaze event was detected. After the trip has ended, the user 301 may then receive or otherwise access this video clip, which can then be shared to various platforms.

Additional examples of detected action profile include a sudden change in viewing direction and/or gaze, thus indicating surprise of the user 301. The detection of a surprise event may match a predetermined action profile, for instance, by tracking the direction of the gaze of the user 301 in the video data during the trip, and identifying a change in the gaze direction that exceeds threshold angular displacement within a threshold period of time. When a surprise event is detected, aspects include the local image and data processing circuitry 502 identifying a field of view of one or more specific outside image acquisition devices 304.1-304.N that is directed towards (so as to capture video in) the new (i.e. subsequent) gaze direction that matches the direction of the user 301's adjusted gaze. As discussed above, the entire 360 degree view of video data available may be reduced to a narrower field of view in the new direction of the user 301's gaze and during a time period when the surprise event was identified. As an illustrative example, the local image and data processing circuitry 502 may process the event data to provide a video clip of video captured en route to or from the airport, which may be captured from the outside image acquisition device 304.3 based upon the orientation of the autonomous vehicle in a direction of the new, adjusted gaze of the user 301 when the surprise event was detected. After the trip has ended, the user 301 may then receive or otherwise access this video clip, which can then be shared to various platforms.

As yet another example of a detected action profile, the user 301 may attempt to take a picture using the mobile electronic device 303. The detection of a such an event of interest may match a predetermined action profile, for instance, by identifying the orientation of the mobile electronic device 303, the proximity of the mobile electronic device 303 to the user 301's face in excess of a threshold period of time, or any other suitable image processing technique to determine that the user 301 is trying to take a picture and the direction of the field of view of such a picture. When an event of interest such as this one is detected, aspects include the local image and data processing circuitry 502 identifying a field of view of one or more specific outside image acquisition devices 304.1-304.N that is directed towards (so as to capture video in) the direction in which the user 301 is directing the mobile electronic device 303 based upon sensor data (e.g. compass data) and the heading of the autonomous vehicle. As discussed above, the entire 360 degree view of video data available may be reduced to a narrower field of view in this new direction and during a time period when the event of interest was identified. As an illustrative example, the local image and data processing circuitry 502 may process the event data to provide a video clip of video captured en route to or from the airport, which may be captured from the outside image acquisition device 304.1 based upon the orientation of the autonomous vehicle in a direction of the mobile electronic device 303 as the user 301 is taking a picture. After the trip has ended, the user 301 may then receive or otherwise access this video clip, which can then be shared to various platforms.

To provide yet another example, the local processing unit 320 may include a user interface that is separate from the safety system 200 or part of the safety system 200 as discussed herein. In any event, the user interface may include one or more touch displays, microphones, etc., that enable the user 301 to interact with the local processing unit 320. In this case, the user 301 may manually identify memorable events inside and/or outside the vehicle (e.g. via a touch display indication, by speaking a command, etc.). The local image and data processing circuitry 502 may then, in response to receiving such a user command, flag the event as indicated by the user 301. The processed event data may then include video data, images, etc., from one or more of the inside image acquisition devices 306.1-306.N and/or the outside image acquisition devices 304.1-304.N based upon the user input, and make this processed event data available to the user 301, which can then be shared to various platforms.

Using event data to provide inside highlights and events using user action profiles

As discussed above, aspects include the local image and data processing circuitry 502 analyzing the video data using one or more suitable image processing techniques to detect one or more events based upon the actions of the user 301 during a trip and/or while an autonomous vehicle navigates (or has navigated) an environment. In the examples above, the video from the outside image acquisition devices 304.1-304.N was processed to provide a narrower field of view based upon an identified action profile of the user 301. However, the video from the inside image acquisition devices 306.1-306.N may additionally or alternatively be used to provide the processed event data for the user 301. For example, the local image and data processing circuitry 502 may generate processed event data in response to any of the aforementioned events described above based upon detecting specific user actions. The processed event data may, as in the previous examples, include edited video data captured from one or more of the outside image acquisition devices 304.1-304.N. However, aspects also include the processed event data additionally or alternatively including edited video data captured from one or more of the inside image acquisition devices 306.1-306.N. Therefore, continuing the examples provided above, the processed event data may include both a video of a field of view matching a direction of a user's gaze as well as a video of the user looking in that direction.

Furthermore, for some types of user actions, it may be more appropriate for the processed event data to include only edited video data captured from one or more of the inside image acquisition devices 306.1-306. Continuing this example, such a detected action profile may include, for example, audio and/or video associated with the user 301 laughing, fast movement of the user 301 (jumping, excitement, etc.), or certain actions of the user 301 such as taking selfies or videos via the electronic mobile device 303. As an illustrative example, the local image and data processing circuitry 502 may process the event data and, when applicable analyze the audio data and/or video data in the event data to identify relevant events. The processed event data may include, as an example, a video clip of video captured en route to or from the airport, which may be captured from the inside image acquisition device 306.1 at the time when the specific type of user activity was detected. After the trip has ended, the user 301 may then receive or otherwise access this video clip, which can then be shared to various platforms.

In other words, the aspects as described herein generally enable the customization or modification of video data initially captured by the various image acquisition devices that may be already present in a vehicle (e.g., an autonomous vehicle or Robo-Taxi) or otherwise installed for this purpose. The initial video data may include a “default” view that is associated with various video feeds recorded from more than one particular image acquisition source (e.g., all or a subset of the inside or outside image acquisition devices). For example, the initial video data that is included as part of the event data may represent a “stitched” view of the environment outside the vehicle (e.g. a 180 degree view, a 360 degree view, etc.) as well as of the inside cameras (a wide field of view around the user 301 such as a 180 degree arc, for example). The aspects as described herein include the local image and data processing circuitry 502 processing this initial video data to provide processed event data that has a smaller field of view targeted towards a particular person or object, different zoom levels (e.g., a “selfie” point of view with respect to the inside of the vehicle and the user 301). The aspects described herein may process this initial video data to output, as the processed event data, video data having any suitable length, format, viewpoint, visual effects, etc. (e.g., zooming around the user 301, providing “bullet time” video, applying filtering or overlays, etc.). Alternatively, the event data may be processed to allow the user 301 to select a desired viewpoint from the stitched 360 view, a specific image acquisition device feed point of view, zoom level, etc., with various amounts of editing being performed on the event data automatically via the local image and data processing circuitry 502 or the user 301 depending upon a user's option or a particular application.

Further, the processed event data may include a combination of video data from various camera sources, such as a combination of video data acquired from some of the outside image acquisition devices 304.1-304.N as well as from some of the inside image acquisition devices 306.1-306.N. As an illustrative example, the processed event data may include a sharable video or photomontage that shows the user 301 from inside the vehicle in addition to outside image data (scenery, landmarks, events, etc.) as one single file formatted for social media posting or use with other suitable platforms. This may be particularly useful, for instance, to show the user 301's reaction and emotion during a specific detected event and, in the same piece of sharable content (e.g. a video or photo) also showing what caused the user 301's reaction when the event was detected.

Again, the processing the initially captured video may include changing the zoom level or cutting the video data down to only include interesting events and specific viewpoints instead of showing the complete field of view as initially captured. In an aspect, the local image and data processing circuitry 502 may use known processing techniques such as object tracking to keep a detected event or object in the frame by continuously adjusting the area of interest during the time period in which the event was detected. For instance, the processed event data may include an image that is “cut out” from the initial video feed data from one or more image of the outside image acquisition devices 304.1-304.N and/or the inside image acquisition devices 306.1-306.N.

Using Event Data with Gesture Recognition

Again, aspects include the local image and data processing circuitry 502 analyzing the video data using one or more suitable image processing techniques to detect one or more events of interest. In accordance with some aspects, the events of interest may be identified using recognized user gestures. For example, as noted above, various techniques (e.g. trained machine learning algorithms) may identify certain user action profiles and identify events of interest when such action profiles are detected. The action profiles may include various user gestures that may trigger or otherwise signal the occurrence of an event of interest and may additionally indicate the location or direction of the event of interest with respect to the user and/or vehicle. For example, a user may point in a specific manner with her hand(s) towards a landmark, trace out a pattern in the air in two or three dimensions, touch her face in a specific manner, etc. In response to the detected gesture, aspects include the local image and data processing circuitry identifying the event of interest and/or generating one or more portions of digital data by selectively applying or stitching together video data for specific camera feeds as noted above based upon the location of the event of interest as identified by the user's gesture, for example. As another example, the user's gesture may indicate a point in time with respect to the event of interest within the event data, and the processed event data may include one or more portions of digital content that represent a 360 degree view, a 180 degree view, etc., associated with cameras disposed outside the vehicle and/or from camera(s) disposed inside the vehicle.

Using Event Data Across Multiple Applications and Platforms

Again, the processed event data may include one or more events of interest that are identified in various ways. The use of user action profiles may be particularly useful, however, to determine user behavior and/or to identify a potential location, landmark, retailer, etc., for which that the user may express a particular interest. Therefore, aspects include exploiting the user action profiles to automatically execute particular applications, which may be stored and executed from the user's mobile electronic device 303, for example.

As an illustrative example, the aforementioned gaze analysis of the event data may identify an object of interest that may include, for instance, a particular building, landmark, etc., which a user is looking at. Aspects include the local image and data processing circuitry 502 identifying the object of interest (e.g., via access of a stored database such as map database 204, external communications with location servers, etc.). Once identified, the digital content may include data or links that identify the object of interest for one or more third-party applications (e.g., mapping utilities, mobile phone operating system applications, etc.). In this way, when the digital content is transferred to a user's mobile electronic device, the mobile electronic device may execute one or more predetermine applications or other suitable actions when the digital content is received or at a later time. For instance, a user's mobile electronic device 303 may display a suitable notification after a trip in the autonomous vehicle has ended that reminds the user of an activity linked to a specific event, in this example the user's previous interest in an identified location or object of interest.

Moreover, the availability of the processed event data may enable the automatic sharing of the digital content across various platforms. For instance, and as noted above, the mobile electronic device 303 may automatically receive the digital content, which may include video and/or images from one or more cameras disposed outside and/or inside the vehicle. Aspects include predetermined views from specific cameras (e.g., an outside camera capturing the field of view of the autonomous vehicle in a forward direction) being transmitted to one or more mobile electronic devices (e.g. mobile electronic device 303) as digital content in addition to or instead of the other digital content as discussed herein that includes events of interest. In this way, the otherwise inaccessible camera feed data may be shared across various platforms in addition to the autonomous vehicle's secure environment systems. The automatic sharing of data in this manner may include, for instance, establishing predetermined camera feeds, users, and/or shared destinations for the digital content to be transmitted. Thus, aspects include users easily and seamlessly accessing data from autonomous vehicle trips across multiple devices, platforms, operating systems, etc.

The use of External Systems in Conjunction with the Autonomous Vehicle Systems

As discussed herein, the autonomous vehicle cameras (e.g., cameras disposed inside and/or outside the vehicle) may be used to create digital content from events of interest. However, the aspects as discussed herein may also utilize external camera systems, i.e., those not associated with the autonomous vehicle. For instance, external cameras such as a camera onboard a stop light, billboard, etc., may implement wireless communications such as V2I, I2V, etc., via the cloud to capture images of the autonomous vehicle. Using optical character recognition processes, the license plate number, serial number of the roof of the vehicle, etc., may be identified. Continuing this example, via communication with the fleet management system or any other suitable repository, the user account that is currently associated with the vehicle can be determined and the one or more portions of digital content can be linked to the user's account and sent to the user.

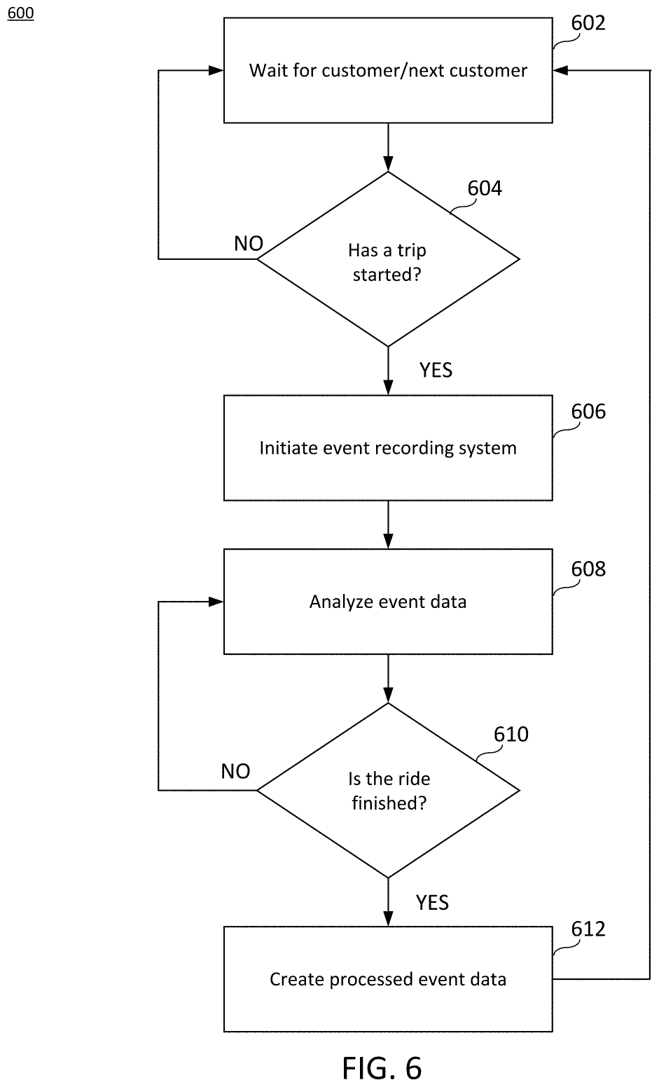

FIG. 6 illustrates an exemplary flow in accordance with various aspects of the present disclosure. With reference to FIG. 6, the flow 600 may be a computer-implemented method executed by and/or otherwise associated with one or more processors and/or storage devices. These processors and/or storage devices may be, for instance, associated the local image and data processing circuitry 502, one or more components of the vehicle safety system 200, or any other suitable components of the local processing unit 320 or the vehicle in which the local processing unit 320 is implemented, as discussed herein. Moreover, in an embodiment, flow 600 may be performed via one or more processors executing instructions stored on a suitable storage medium (e.g., a non-transitory computer-readable storage medium) such as the local image and data processing circuitry 502 executing instructions stored in the memory 503, for instance. In an aspect, the flow 600 may describe an overall operation to access and process event data associated with a user's trip in a vehicle, such as an autonomous vehicle, a Robo-Taxi, etc., as discussed herein. Aspects may include alternate or additional steps that are not shown in FIG. 6 for purposes of brevity, and may be performed in a different order than the example steps shown in FIG. 6.

Flow 600 may begin when one or more processors wait (block 602) for the next user or customer. This may include, for instance, the local image and data processing circuitry 502 operating in a standby mode awaiting a new trip request.

Flow 600 may include one or more processors determining (block 604) whether a trip has started. This may include, for example, the local image and data processing circuitry 502 receiving an indication that the vehicle in which it is implemented has arrived at an origin location associated with a start of a requested trip or that the current time matches a requested trip start time. As another example, this determination may be made by detecting a connection to the user's electronic mobile device 303 via one or more communication systems implemented by the local image and data processing circuitry 502 (e.g. the data connectivity circuitry 504A), or by receiving communications from an appropriate ride service provider used for servicing rides for users. As yet another example, the determination may be made by various sensors or image acquisition devices that recognize the user approaching the vehicle or entering the vehicle. Once it has been determined that the trip has started, the flow 600 may continue. Otherwise, the flow 600 may include continuing to wait for the user/customer (block 602).

Flow 600 may include one or more processors initiating (block 606) an event recording system. This may include, for example, the local image and data processing circuitry 502 receiving and/or storing the event data received via a security mechanism from the vehicle's local vehicle network system, as discussed herein.

Flow 600 may include one or more processors analyzing (block 608) the event data to identify one or more events and to generate processed event data associated with these detected events, such as images, videos, etc., that are formatted to be shared to one or more suitable platforms. Although shown in FIG. 6 as occurring prior to the end of the trip, this step may occur during the trip or once the trip has been finished, in various aspects.

Flow 600 may include one or more processors determining (block 610) whether a trip has ended. This may include, for example, the local image and data processing circuitry 502 receiving an indication that the vehicle in which it is implemented has arrived at a destination associated with a requested trip. As another example, this determination may be made by receiving an indication that the trip has ended via an appropriate ride service provider used for servicing rides for users. As yet another example, the determination may be made by various sensors or image acquisition devices that recognize the user is leaving the vehicle. Once it has been determined that the trip has ended, the flow 600 may continue. Otherwise, the flow 600 may include continuing to analyze the event data (block 608).

Flow 600 may include one or more processors creating (block 612) processed event data. Again, this event data may include a trip summary and/or one or more pieces of sharable digital content based upon the analysis of the event data (block 608). Although shown in FIG. 6 as occurring after the trip has ended, this step may additionally or alternatively occur during the ride, such as part of the analysis of the event data (block 608) descried above. Once the event data has been processed to create the processed event data, the processed event data may be provided to the user, such as via one or more of the communication techniques as described herein with reference to FIGS. 4A-4B. Once the processed event data is created, the flow 600 may repeat by reverting back to continuing to wait for the next user/customer (block 602). Of course, although referenced as a “customer” in FIG. 6, the flow 600, as well as the other aspects described herein, may be used with respect to any user located within a vehicle during, prior to, or after a trip has occurred.

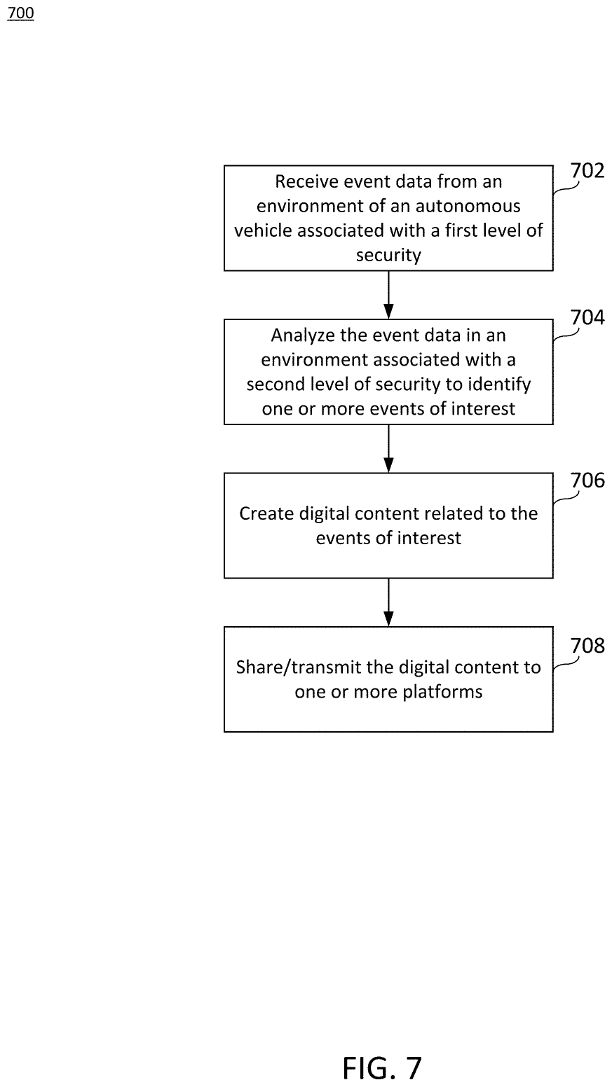

FIG. 7 illustrates an exemplary flow in accordance with various aspects of the present disclosure. As discussed above with reference to FIG. 6, the flow 700 may be a computer-implemented method executed by and/or otherwise associated with one or more processors and/or storage devices. These processors and/or storage devices may be, for instance, associated the local image and data processing circuitry 502, one or more components of the vehicle safety system 200, or any other suitable components of the local processing unit 320 or the vehicle in which the local processing unit 320 is implemented, as discussed herein. Moreover, in an embodiment, flow 700 may be performed via one or more processors executing instructions stored on a suitable storage medium (e.g., a non-transitory computer-readable storage medium) such as the local image and data processing circuitry 502 executing instructions stored in the memory 503, for instance. In an aspect, the flow 700 may describe an overall operation to receive and analyze event data to generate processed event data associated with a user's trip in a vehicle or when an autonomous vehicle (e.g. a Robo-Taxi) has or is currently navigating within a particular environment, as discussed herein. Aspects may include alternate or additional steps that are not shown in FIG. 7 for purposes of brevity, and may be performed in a different order than the example steps shown in FIG. 7.

Flow 700 may include one or more processors receiving (block 702) event data via the secure environment of an autonomous vehicle. This may include, for example, the local image and data processing circuitry 502 receiving and/or storing the event data received via a security mechanism from the vehicle's local vehicle network system, as discussed herein.

Flow 700 may include one or more processors analyzing (block 704) the event data within an unsecure environment to identify one or more events of interest. Although shown in FIG. 7 as occurring prior to the end of the trip, this step may occur while the autonomous vehicle navigates a particular environment or once the trip has been finished, in various aspects. The analysis of the event data may include, for instance, the local image and data processing circuitry 502 perfuming audio analysis, image analysis, the use of locations, action profile recognition, etc., to identify events of interest from among the event data.

Flow 700 may include one or more processors creating or generating (block 706) processed event data, which may include one or more portions of digital content. This digital content may, for instance, be images, videos, etc., that are formatted to be shared to one or more suitable platforms.

Flow 700 may include one or more processors sharing or transmitting (block 708) the digital content to one or more platforms. This may include, for instance, a user downloading the digital content to a smartphone or other suitable device, a user posting the digital content to a suitable platform, etc.

The flows 600, 700 include the transmission of processed event data in accordance with any suitable transmission medium. For instance, in aspects in which the event data is transmitted to another processing component external to the host autonomous vehicle (e.g., a cloud-based processing system associated with the cloud 402), the analysis (blocks 608, 704) may be performed via the external processing system. In such a case, although not shown in FIGS. 6 and 7 for purposes of brevity, the flows 600, 700 may additionally include a privacy or anonymization step prior to transmitting the event data from the host autonomous vehicle, as the event data may include user data that may be of a private nature as discussed herein.

Use in Various Models

Although the various aspects described herein may be applied to any suitable type of vehicle, there are some advantages in the context of other types of applications or models. These may be particularly relevant for ride sharing services, autonomous vehicle ride-for-hire services, Robo-Taxi services, etc. For example, in the context of such applications, users (e.g. customers) may prefer to select a special brand of service provider due to their fleet being equipped with social media experience enrichment technology as described herein.

As another potential advantage, users could post the processed event data to one or more social media platforms by manually or automatically editing the data provided by the system to identify the operator company or brand, thus gaining rebates or bonus points for future rides or services in exchange for doing so. Furthermore, and more generally, social media posts may be supplemented or integrated with watermarks, photos, video advertisements, etc., for the Robo-taxi operator. Alternatively, advertisements sold by the operator for third party goods and services may be automatically generated and included in such posts. The resulting advertisement shown/delivered may also be based on the current location of the vehicle or the destination of the ride to create targeted advertising experiences.

As another example, advertisements may be made and presented within the vehicle in a manner that leverages video streams shown from outside the vehicle. For instance, the events may be detected by identifying a specific store brand, restaurant, etc., that is detected by location (e.g. geolocation comparison), object recognition, or by recognizing the store's sign in the image data (e.g., using OCR algorithms). As an alternative to providing this processed event data to the user for sharing to social media, the processed event data may instead be displayed within the vehicle and include an overlay of an interactive, clickable advertisement imagery.

As another example, because the video feed from outside the vehicle may be presented to the user inside the vehicle or shared on social media platforms, this may be leveraged by third party advertisers. For instance, the aspects described herein may determine a route for a trip that offers a user a discount for passing by preferred locations, and may offer the user a fare discount for doing so. In other words, a user may be presented with two trip route options, one offering a discount for taking a route that is more likely to provide additional exposure for preferred locations and another that does not. Thus, the aspects described herein may advantageously leverage the use of marketing techniques known as attention, interest, desire, and action (AIDA). Aspects further include leveraging the use of such data to identify and evaluate passenger (or user) engagement, e.g. by determining if the user is looking outside the vehicle towards an advertisement or any other sensory stimuli.

### EXAMPLES

The following examples pertain to further aspects.

Example 1 is a system for processing autonomous vehicle data, comprising: a security mechanism configured to receive data from an environment of an autonomous vehicle associated with a first level of security, the data including one or more images captured by one or more cameras associated with a navigated environment of the autonomous vehicle; and one or more processors configured to analyze the data that is received via the security mechanism in an environment associated with a second level of security to generate one or more portions of digital content for transmission to one or more platforms, wherein the first level of security is greater than the second level of security.

In Example 2, the subject matter of Example 1, wherein the one or more processors are associated with local processing circuitry in the autonomous vehicle.

In Example 3, the subject matter of any combination of Examples 1-2, wherein the one or more processors are associated with a cloud-computing system.

In Example 4, the subject matter of any combination of Examples 1-3, wherein the one or more processors are configured to perform image processing to process the one or more images included in the data to detect an event of interest by identifying, from the data, one or more actions of a person located within the autonomous vehicle matching a predetermined action profile.

In Example 5, the subject matter of any combination of Examples 1-4, wherein the one or more processors are configured to execute a machine learning algorithm that is trained in accordance with a plurality of different action profiles, and wherein the one or more processors are configured to perform image processing to detect the event of interest by classifying the one or more actions of the person located within the autonomous vehicle as the predetermined action profile based upon the trained machine learning algorithm.

In Example 6, the subject matter of any combination of Examples 1-5, wherein the one or more processors are configured to detect a gazing event as the event of interest by identifying, as the one or more actions of the person located within the autonomous vehicle, a gaze of the person in a direction that exceeds a time period threshold, and wherein the one or more portions of digital content include a video captured by one or more cameras disposed outside of the autonomous vehicle in a direction that matches the direction of the gaze of the person when the gazing event was detected

In Example 7, the subject matter of any combination of Examples 1-6, wherein the predetermined action profile includes a gesture performed by a person located within the autonomous vehicle identifying an event of interest, and wherein the one or more processors are configured to detect the event of interest by identifying the gesture of the person matching a predetermined gesture.

In Example 8, the subject matter of any combination of Examples 1-7, wherein the data includes location data representing one or more geographic locations associated with the navigated environment of the autonomous vehicle, and wherein the one or more processors are configured to detect the event of interest based upon a comparison of one or more geographic locations included in the location data with one or more predetermined geographic locations.

Example 9 is an autonomous vehicle (AV), comprising: a data interface configured to provide data from an environment of an AV associated with a first level of security, the data including one or more images captured by one or more cameras associated with a navigated environment of the AV; and local processing circuitry configured to receive the data provided by the interface via a security mechanism, and to analyze the data in an environment associated with a second level of security to generate one or more portions of digital content for transmission to one or more platforms, wherein the first level of security is greater than the second level of security.

In Example 10, the subject matter of Example 9, wherein the local processing circuitry is configured to analyze the data to detect an event of interest based upon at least one image from the one or more images, and wherein the one or more portions of digital content correspond to the detected event of interest.

In Example 11, the subject matter of any combination of Examples 9-10, wherein the data includes location data representing one or more geographic locations associated with the navigated environment, and wherein the local processing circuitry is configured to detect the event of interest based upon a comparison of one or more geographic locations included in the location data with one or more predetermined geographic locations.

In Example 12, the subject matter of any combination of Examples 9-11. The AV of claim 9, wherein the local processing circuitry is configured to perform image processing to process the one or more images included in the data to detect an event of interest by identifying, from the data, one or more actions of a person located within the autonomous vehicle matching a predetermined action profile.

In Example 13, the subject matter of any combination of Examples 9-12, wherein the local processing circuitry is configured to execute a machine learning algorithm that is trained in accordance with a plurality of different action profiles, and to perform image processing to detect the event of interest by classifying the one or more actions of the person located within the autonomous vehicle as the predetermined action profile based upon the trained machine learning algorithm.

In Example 14, the subject matter of any combination of Examples 9-13, wherein the local processing circuitry is configured to detect a gazing event as the event of interest by identifying, as the one or more actions of the person located within the autonomous vehicle, a gaze of the person in a direction that exceeds a time period threshold, and wherein the one or more portions of digital content include a video captured by one or more cameras disposed outside of the AV in a direction that matches the direction of the gaze of the person when the gazing event was detected.

In Example 15, the subject matter of any combination of Examples 9-14, wherein the predetermined action profile includes a gesture performed by a person located within the AV identifying an event of interest, and wherein the local processing circuitry is configured to detect the event of interest by identifying the gesture of the person matching a predetermined gesture.

Example 16 is a non-transitory computer-readable medium having instructions stored thereon that, when executed by one or more processors associated with an autonomous vehicle (AV), cause the AV to: receive data from an environment of the AV associated with a first level of security, the data being received via a security mechanism and including one or more images captured by one or more cameras associated with a navigated environment of the AV; and analyze the data that is received via the security mechanism in an environment associated with a second level of security to generate one or more portions of digital content for transmission to one or more platforms, wherein the first level of security is greater than the second level of security.

In Example 17, the subject matter of Example 16, further including instructions that, when executed by the one or more processors of the AV, cause the AV to analyze the data to detect an event of interest based upon at least one image from the one or more images, and wherein the one or more portions of digital content correspond to the detected event of interest.

In Example 18, the subject matter of any combination of Examples 16-17, wherein the data includes location data representing one or more geographic locations associated with the navigated environment, and further including instructions that, when executed by the one or more processors of the AV, cause the AV to detect the event of interest based upon a comparison of one or more geographic locations included in the location data with one or more predetermined geographic locations.

In Example 19, the subject matter of any combination of Examples 16-18, further including instructions that, when executed by the one or more processors of the AV, cause the AV to perform image processing to process the one or more images included in the data to detect an event of interest by identifying, from the data, one or more actions of a person located within the autonomous vehicle matching a predetermined action profile.

In Example 20, the subject matter of any combination of Examples 16-19, further including instructions that, when executed by the one or more processors of the AV, cause the AV to execute a machine learning algorithm that is trained in accordance with a plurality of different action profiles, and to perform image processing to detect the event of interest by classifying the one or more actions of the person located within the autonomous vehicle as the predetermined action profile based upon the trained machine learning algorithm.

In Example 21, the subject matter of any combination of Examples 16-20, further including instructions that, when executed by the one or more processors of the AV, cause the AV to detect a gazing event as the event of interest by identifying, as the one or more actions of the person located within the autonomous vehicle, a gaze of the person in a direction that exceeds a time period threshold, and wherein the one or more portions of digital content include a video captured by one or more cameras disposed outside of the AV in a direction that matches the direction of the gaze of the person when the gazing event was detected.

In Example 22, the subject matter of any combination of Examples 16-21, wherein the predetermined action profile includes a gesture performed by a person located within the AV identifying an event of interest, and further including instructions that, when executed by the one or more processors of the AV, cause the AV to detect the event of interest by identifying the gesture of the person matching a predetermined gesture.

Example 23 is a means for processing autonomous vehicle data, comprising: a security means for receiving data from an environment of an autonomous vehicle associated with a first level of security, the data including one or more images captured by one or more cameras associated with a navigated environment of the autonomous vehicle; and one or more processing means for analyzing the data that is received via the security means in an environment associated with a second level of security to generate one or more portions of digital content for transmission to one or more platforms, wherein the first level of security is greater than the second level of security.

In Example 24, the subject matter of Example 23, wherein the one or more processing means are associated with local processing circuitry in the autonomous vehicle.

In Example 25, the subject matter of any combination of Examples 23-24, wherein the one or more processing means are associated with a cloud-computing system.

In Example 26, the subject matter of any combination of Examples 23-25, wherein the one or more processing means perform image processing to process the one or more images included in the data to detect an event of interest by identifying, from the data, one or more actions of a person located within the autonomous vehicle matching a predetermined action profile.

In Example 27, the subject matter of any combination of Examples 23-26, wherein the one or more processing means execute a machine learning algorithm that is trained in accordance with a plurality of different action profiles, and wherein the one or more processing means perform image processing to detect the event of interest by classifying the one or more actions of the person located within the autonomous vehicle as the predetermined action profile based upon the trained machine learning algorithm.

In Example 28, the subject matter of any combination of Examples 23-27, wherein the one or more processing means detect a gazing event as the event of interest by identifying, as the one or more actions of the person located within the autonomous vehicle, a gaze of the person in a direction that exceeds a time period threshold, and wherein the one or more portions of digital content include a video captured by one or more cameras disposed outside of the autonomous vehicle in a direction that matches the direction of the gaze of the person when the gazing event was detected.

In Example 29, the subject matter of any combination of Examples 23-28, wherein the predetermined action profile includes a gesture performed by a person located within the autonomous vehicle identifying an event of interest, and wherein the one or more processing means detect the event of interest by identifying the gesture of the person matching a predetermined gesture.

In Example 30, the subject matter of any combination of Examples 23-29, wherein the data includes location data representing one or more geographic locations associated with the navigated environment of the autonomous vehicle, and wherein the one or more processing means detect the event of interest based upon a comparison of one or more geographic locations included in the location data with one or more predetermined geographic locations.

Example 31 is an autonomous vehicle (AV), comprising: a data interface processing means for providing data from an environment of an AV associated with a first level of security, the data including one or more images captured by one or more cameras associated with a navigated environment of the AV; and local processing means receiving the data provided by the interface via a security means, and analyzing the data in an environment associated with a second level of security to generate one or more portions of digital content for transmission to one or more platforms, wherein the first level of security is greater than the second level of security.

In Example 32, the subject matter of Example 31, wherein the local processing means analyzes the data to detect an event of interest based upon at least one image from the one or more images, and wherein the one or more portions of digital content correspond to the detected event of interest.

In Example 33, the subject matter of any combination of Examples 31-32, wherein the data includes location data representing one or more geographic locations associated with the navigated environment, and wherein the local processing circuitry is configured to detect the event of interest based upon a comparison of one or more geographic locations included in the location data with one or more predetermined geographic locations.

In Example 34, the subject matter of any combination of Examples 31-33, wherein the local processing means performs image processing to process the one or more images included in the data to detect an event of interest by identifying, from the data, one or more actions of a person located within the autonomous vehicle matching a predetermined action profile.

In Example 35, the subject matter of any combination of Examples 31-34, wherein the local processing means executes a machine learning algorithm that is trained in accordance with a plurality of different action profiles, and performs image processing to detect the event of interest by classifying the one or more actions of the person located within the autonomous vehicle as the predetermined action profile based upon the trained machine learning algorithm.

In Example 36, the subject matter of any combination of Examples 31-35, wherein the local processing means detects a gazing event as the event of interest by identifying, as the one or more actions of the person located within the autonomous vehicle, a gaze of the person in a direction that exceeds a time period threshold, and wherein the one or more portions of digital content include a video captured by one or more cameras disposed outside of the AV in a direction that matches the direction of the gaze of the person when the gazing event was detected.

In Example 37, the subject matter of any combination of Examples 31-36, wherein the predetermined action profile includes a gesture performed by a person located within the AV identifying an event of interest, and wherein the local processing means detects the event of interest by identifying the gesture of the person matching a predetermined gesture.

Example 38 is a non-transitory computer-readable medium means having instructions stored thereon that, when executed by one or more processing means associated with an autonomous vehicle (AV), cause the AV to: receive data from an environment of the AV associated with a first level of security, the data being received via a security means and including one or more images captured by one or more cameras associated with a navigated environment of the AV; and analyze the data that is received via the security means in an environment associated with a second level of security to generate one or more portions of digital content for transmission to one or more platforms, wherein the first level of security is greater than the second level of security.

In Example 39, the subject matter of Example 38, further including instructions that, when executed by the one or more processing means of the AV, cause the AV to analyze the data to detect an event of interest based upon at least one image from the one or more images, and wherein the one or more portions of digital content correspond to the detected event of interest.

In Example 40, the subject matter of any combination of Examples 38-39, wherein the data includes location data representing one or more geographic locations associated with the navigated environment, and further including instructions that, when executed by the one or more processing means of the AV, cause the AV to detect the event of interest based upon a comparison of one or more geographic locations included in the location data with one or more predetermined geographic locations.

In Example 41, the subject matter of any combination of Examples 38-40, further including instructions that, when executed by the one or more processing means of the AV, cause the AV to perform image processing to process the one or more images included in the data to detect an event of interest by identifying, from the data, one or more actions of a person located within the autonomous vehicle matching a predetermined action profile.

In Example 42, the subject matter of any combination of Examples 38-41, further including instructions that, when executed by the one or more processing means of the AV, cause the AV to execute a machine learning algorithm that is trained in accordance with a plurality of different action profiles, and to perform image processing to detect the event of interest by classifying the one or more actions of the person located within the autonomous vehicle as the predetermined action profile based upon the trained machine learning algorithm.

In Example 43, the subject matter of any combination of Examples 38-42, further including instructions that, when executed by the one or more processing means of the AV, cause the AV to detect a gazing event as the event of interest by identifying, as the one or more actions of the person located within the autonomous vehicle, a gaze of the person in a direction that exceeds a time period threshold, and wherein the one or more portions of digital content include a video captured by one or more cameras disposed outside of the AV in a direction that matches the direction of the gaze of the person when the gazing event was detected.

In Example 44, the subject matter of any combination of Examples 38-43, wherein the predetermined action profile includes a gesture performed by a person located within the AV identifying an event of interest, and further including instructions that, when executed by the one or more processing means of the AV, cause the AV to detect the event of interest by identifying the gesture of the person matching a predetermined gesture.

An apparatus as shown and described.

A method as shown and described.

### Conclusion

The aforementioned description of the specific aspects will so fully reveal the general nature of the disclosure that others can, by applying knowledge within the skill of the art, readily modify and/or adapt for various applications such specific aspects, without undue experimentation, and without departing from the general concept of the present disclosure. Therefore, such adaptations and modifications are intended to be within the meaning and range of equivalents of the disclosed aspects, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

References in the specification to “one aspect,” “an aspect,” “an exemplary aspect,” etc., indicate that the aspect described may include a particular feature, structure, or characteristic, but every aspect may not necessarily include the particular feature, structure, or characteristic. Moreover, such phrases are not necessarily referring to the same aspect. Further, when a particular feature, structure, or characteristic is described in connection with an aspect, it is submitted that it is within the knowledge of one skilled in the art to affect such feature, structure, or characteristic in connection with other aspects whether or not explicitly described.

The exemplary aspects described herein are provided for illustrative purposes, and are not limiting. Other exemplary aspects are possible, and modifications may be made to the exemplary aspects. Therefore, the specification is not meant to limit the disclosure. Rather, the scope of the disclosure is defined only in accordance with the following claims and their equivalents.

Aspects may be implemented in hardware (e.g., circuits), firmware, software, or any combination thereof. Aspects may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact results from computing devices, processors, controllers, or other devices executing the firmware, software, routines, instructions, etc. Further, any of the implementation variations may be carried out by a general purpose computer.

The word “exemplary” is used herein to mean “serving as an example, instance, or illustration”. Any embodiment or design described herein as “exemplary” is not necessarily to be construed as preferred or advantageous over other embodiments or designs.

Throughout the drawings, it should be noted that like reference numbers are used to depict the same or similar elements, features, and structures, unless otherwise noted.

The terms “at least one” and “one or more” may be understood to include a numerical quantity greater than or equal to one (e.g., one, two, three, four, [. . . ], etc.). The term “a plurality” may be understood to include a numerical quantity greater than or equal to two (e.g., two, three, four, five, [. . . ], etc.).

The words “plural” and “multiple” in the description and in the claims expressly refer to a quantity greater than one. Accordingly, any phrases explicitly invoking the aforementioned words (e.g., “plural [elements]”, “multiple [elements]”) referring to a quantity of elements expressly refers to more than one of the said elements. The terms “group (of)”, “set (of)”, “collection (of)”, “series (of)”, “sequence (of)”, “grouping (of)”, etc., and the like in the description and in the claims, if any, refer to a quantity equal to or greater than one, i.e., one or more. The terms “proper subset”, “reduced subset”, and “lesser subset” refer to a subset of a set that is not equal to the set, illustratively, referring to a subset of a set that contains less elements than the set.

The phrase “at least one of” with regard to a group of elements may be used herein to mean at least one element from the group consisting of the elements. For example, the phrase “at least one of” with regard to a group of elements may be used herein to mean a selection of: one of the listed elements, a plurality of one of the listed elements, a plurality of individual listed elements, or a plurality of a multiple of individual listed elements.

The term “data” as used herein may be understood to include information in any suitable analog or digital form, e.g., provided as a file, a portion of a file, a set of files, a signal or stream, a portion of a signal or stream, a set of signals or streams, and the like. Further, the term “data” may also be used to mean a reference to information, e.g., in form of a pointer. The term “data”, however, is not limited to the aforementioned examples and may take various forms and represent any information as understood in the art.

The terms “processor” or “controller” as, for example, used herein may be understood as any kind of technological entity that allows handling of data. The data may be handled according to one or more specific functions executed by the processor or controller. Further, a processor or controller as used herein may be understood as any kind of circuit, e.g., any kind of analog or digital circuit. A processor or a controller may thus be or include an analog circuit, digital circuit, mixed-signal circuit, logic circuit, processor, microprocessor, Central Processing Unit (CPU), Graphics Processing Unit (GPU), Digital Signal Processor (DSP), Field Programmable Gate Array (FPGA), integrated circuit, Application Specific Integrated Circuit (ASIC), etc., or any combination thereof. Any other kind of implementation of the respective functions, which will be described below in further detail, may also be understood as a processor, controller, or logic circuit. It is understood that any two (or more) of the processors, controllers, or logic circuits detailed herein may be realized as a single entity with equivalent functionality or the like, and conversely that any single processor, controller, or logic circuit detailed herein may be realized as two (or more) separate entities with equivalent functionality or the like.

As used herein, “memory” is understood as a computer-readable medium in which data or information can be stored for retrieval. References to “memory” included herein may thus be understood as referring to volatile or non-volatile memory, including random access memory (RAM), read-only memory (ROM), flash memory, solid-state storage, magnetic tape, hard disk drive, optical drive, among others, or any combination thereof. Registers, shift registers, processor registers, data buffers, among others, are also embraced herein by the term memory. The term “software” refers to any type of executable instruction, including firmware.

In one or more of the exemplary aspects described herein, processing circuitry can include memory that stores data and/or instructions. The memory can be any well-known volatile and/or non-volatile memory, including, for example, read-only memory (ROM), random access memory (RAM), flash memory, a magnetic storage media, an optical disc, erasable programmable read only memory (EPROM), and programmable read only memory (PROM). The memory can be non-removable, removable, or a combination of both.

Unless explicitly specified, the term “transmit” encompasses both direct (point-to-point) and indirect transmission (via one or more intermediary points). Similarly, the term “receive” encompasses both direct and indirect reception. Furthermore, the terms “transmit,” “receive,” “communicate,” and other similar terms encompass both physical transmission (e.g., the transmission of radio signals) and logical transmission (e.g., the transmission of digital data over a logical software-level connection). For example, a processor or controller may transmit or receive data over a software-level connection with another processor or controller in the form of radio signals, where the physical transmission and reception is handled by radio-layer components such as RF transceivers and antennas, and the logical transmission and reception over the software-level connection is performed by the processors or controllers. The term “communicate” encompasses one or both of transmitting and receiving, i.e., unidirectional or bidirectional communication in one or both of the incoming and outgoing directions. The term “calculate” encompasses both ‘direct’ calculations via a mathematical expression/formula/relationship and ‘indirect’ calculations via lookup or hash tables and other array indexing or searching operations.

A “vehicle” may be understood to include any type of driven object. By way of example, a vehicle may be a driven object with a combustion engine, a reaction engine, an electrically driven object, a hybrid driven object, or a combination thereof. A vehicle may be or may include an automobile, a bus, a mini bus, a van, a truck, a mobile home, a vehicle trailer, a motorcycle, a bicycle, a tricycle, a train locomotive, a train wagon, a moving robot, a personal transporter, a boat, a ship, a submersible, a submarine, a drone, an aircraft, a rocket, and the like.

A “ground vehicle” may be understood to include any type of vehicle, as described above, which is driven on the ground, e.g., on a street, on a road, on a track, on one or more rails, off-road, etc..

The term “autonomous vehicle” may describe a vehicle that implements all or substantially all navigational changes, at least during some (significant) part (spatial or temporal, e.g., in certain areas, or when ambient conditions are fair, or on highways, or above or below a certain speed) of some drives. Sometimes an “autonomous vehicle” is distinguished from a “partially autonomous vehicle” or a “semi-autonomous vehicle” to indicate that the vehicle is capable of implementing some (but not all) navigational changes, possibly at certain times, under certain conditions, or in certain areas. A navigational change may describe or include a change in one or more of steering, braking, or acceleration/deceleration of the vehicle. A vehicle may be described as autonomous even in case the vehicle is not fully automatic (for example, fully operational with driver or without driver input). Autonomous vehicles may include those vehicles that can operate under driver control during certain time periods and without driver control during other time periods. Autonomous vehicles may also include vehicles that control only some aspects of vehicle navigation, such as steering (e.g., to maintain a vehicle course between vehicle lane constraints) or some steering operations under certain circumstances (but not under all circumstances), but may leave other aspects of vehicle navigation to the driver (e.g., braking or braking under certain circumstances). Autonomous vehicles may also include vehicles that share the control of one or more aspects of vehicle navigation under certain circumstances (e.g., hands-on, such as responsive to a driver input) and vehicles that control one or more aspects of vehicle navigation under certain circumstances (e.g., hands-off, such as independent of driver input). Autonomous vehicles may also include vehicles that control one or more aspects of vehicle navigation under certain circumstances, such as under certain environmental conditions (e.g., spatial areas, roadway conditions). In some aspects, autonomous vehicles may handle some or all aspects of braking, speed control, velocity control, and/or steering of the vehicle. An autonomous vehicle may include those vehicles that can operate without a driver. The level of autonomy of a vehicle may be described or determined by the Society of Automotive Engineers (SAE) level of the vehicle (e.g., as defined by the SAE, for example in SAE J3016 2018: Taxonomy and definitions for terms related to driving automation systems for on road motor vehicles) or by other relevant professional organizations. The SAE level may have a value ranging from a minimum level, e.g. level 0 (illustratively, substantially no driving automation), to a maximum level, e.g. level 5 (illustratively, full driving automation).

What is claimed is:

1. A system for processing autonomous vehicle data, comprising:
a security mechanism configured to receive data from an environment of an autonomous vehicle associated with a first level of security, the data including one or more images captured by one or more cameras associated with a navigated environment of the autonomous vehicle; and
one or more processors configured to analyze the data that is received via the security mechanism in an environment associated with a second level of security to generate one or more portions of digital content for transmission to one or more platforms,
wherein the first level of security is greater than the second level of security.

2. The system of claim 1, wherein the one or more processors are associated with local processing circuitry in the autonomous vehicle.

3. The system of claim 1, wherein the one or more processors are associated with a cloud-computing system.

4. The system of claim 1, wherein the one or more processors are configured to perform image processing to process the one or more images included in the data to detect an event of interest by identifying, from the data, one or more actions of a person located within the autonomous vehicle matching a predetermined action profile.

5. The system of claim 4, wherein the one or more processors are configured to execute a machine learning algorithm that is trained in accordance with a plurality of different action profiles, and
wherein the one or more processors are configured to perform image processing to detect the event of interest by classifying the one or more actions of the person located within the autonomous vehicle as the predetermined action profile based upon the trained machine learning algorithm.

6. The system of claim 4, wherein the one or more processors are configured to detect a gazing event as the event of interest by identifying, as the one or more actions of the person located within the autonomous vehicle, a gaze of the person in a direction that exceeds a time period threshold, and
wherein the one or more portions of digital content include a video captured by one or more cameras disposed outside of the autonomous vehicle in a direction that matches the direction of the gaze of the person when the gazing event was detected.

7. The system of claim 4, wherein the predetermined action profile includes a gesture performed by a person located within the autonomous vehicle identifying an event of interest, and
wherein the one or more processors are configured to detect the event of interest by identifying the gesture of the person matching a predetermined gesture.

8. The system of claim 1, wherein the data includes location data representing one or more geographic locations associated with the navigated environment of the autonomous vehicle, and
wherein the one or more processors are configured to detect the event of interest based upon a comparison of one or more geographic locations included in the location data with one or more predetermined geographic locations.

9. An autonomous vehicle (AV), comprising:
a data interface configured to provide data from an environment of an AV associated with a first level of security, the data including one or more images captured by one or more cameras associated with a navigated environment of the AV; and
local processing circuitry configured to receive the data provided by the interface via a security mechanism, and to analyze the data in an environment associated with a second level of security to generate one or more portions of digital content for transmission to one or more platforms,
wherein the first level of security is greater than the second level of security.

10. The AV of claim 9, wherein the local processing circuitry is configured to analyze the data to detect an event of interest based upon at least one image from the one or more images, and
wherein the one or more portions of digital content correspond to the detected event of interest.

11. The AV of claim 9, wherein the data includes location data representing one or more geographic locations associated with the navigated environment, and
wherein the local processing circuitry is configured to detect the event of interest based upon a comparison of one or more geographic locations included in the location data with one or more predetermined geographic locations.

12. The AV of claim 9, wherein the local processing circuitry is configured to perform image processing to process the one or more images included in the data to detect an event of interest by identifying, from the data, one or more actions of a person located within the autonomous vehicle matching a predetermined action profile.

13. The AV of claim 12, wherein the local processing circuitry is configured to execute a machine learning algorithm that is trained in accordance with a plurality of different action profiles, and to perform image processing to detect the event of interest by classifying the one or more actions of the person located within the autonomous vehicle as the predetermined action profile based upon the trained machine learning algorithm.

14. The AV of claim 12, wherein the local processing circuitry is configured to detect a gazing event as the event of interest by identifying, as the one or more actions of the person located within the autonomous vehicle, a gaze of the person in a direction that exceeds a time period threshold, and
wherein the one or more portions of digital content include a video captured by one or more cameras disposed outside of the AV in a direction that matches the direction of the gaze of the person when the gazing event was detected.

15. The AV of claim 12, wherein the predetermined action profile includes a gesture performed by a person located within the AV identifying an event of interest, and
wherein the local processing circuitry is configured to detect the event of interest by identifying the gesture of the person matching a predetermined gesture.

16. A non-transitory computer-readable medium having instructions stored thereon that, when executed by one or more processors associated with an autonomous vehicle (AV), cause the AV to:
receive data from an environment of the AV associated with a first level of security, the data being received via a security mechanism and including one or more images captured by one or more cameras associated with a navigated environment of the AV; and
analyze the data that is received via the security mechanism in an environment associated with a second level of security to generate one or more portions of digital content for transmission to one or more platforms,
wherein the first level of security is greater than the second level of security.

17. The non-transitory computer-readable medium of claim 16, further including instructions that, when executed by the one or more processors of the AV, cause the AV to analyze the data to detect an event of interest based upon at least one image from the one or more images, and
wherein the one or more portions of digital content correspond to the detected event of interest.

18. The non-transitory computer-readable medium of claim 16, wherein the data includes location data representing one or more geographic locations associated with the navigated environment, and further including instructions that, when executed by the one or more processors of the AV, cause the AV to detect the event of interest based upon a comparison of one or more geographic locations included in the location data with one or more predetermined geographic locations.

19. The non-transitory computer-readable medium of claim 16, further including instructions that, when executed by the one or more processors of the AV, cause the AV to perform image processing to process the one or more images included in the data to detect an event of interest by identifying, from the data, one or more actions of a person located within the autonomous vehicle matching a predetermined action profile.

20. The non-transitory computer-readable medium of claim 19, further including instructions that, when executed by the one or more processors of the AV, cause the AV to execute a machine learning algorithm that is trained in accordance with a plurality of different action profiles, and to perform image processing to detect the event of interest by classifying the one or more actions of the person located within the autonomous vehicle as the predetermined action profile based upon the trained machine learning algorithm.

21. The non-transitory computer-readable medium of claim 19, further including instructions that, when executed by the one or more processors of the AV, cause the AV to detect a gazing event as the event of interest by identifying, as the one or more actions of the person located within the autonomous vehicle, a gaze of the person in a direction that exceeds a time period threshold, and
wherein the one or more portions of digital content include a video captured by one or more cameras disposed outside of the AV in a direction that matches the direction of the gaze of the person when the gazing event was detected.

22. The non-transitory computer-readable medium of claim 19, wherein the predetermined action profile includes a gesture performed by a person located within the AV identifying an event of interest, and further including instructions that, when executed by the one or more processors of the AV, cause the AV to detect the event of interest by identifying the gesture of the person matching a predetermined gesture.
